(19) United States
(12) Patent Application Publication
(10) Pub. No.: US 2012/0111232 A1
(43) Pub. Date: May 10, 2012

(54) TREATING SOLUTION FOR FORMING FLUORIDE COATING FILM AND METHOD FOR FORMING FLUORIDE COATING FILM

(76) Inventors: Matahiro Komuro, Hitachi (JP); Yuichi Satsu, Hitachi (JP); Yoshii Morishita, Tsukuba (JP); Shigeaki Funyu, Tsuchiura (JP); Mitsuo Katayose, Tsukuba (JP)

(21) Appl. No.: 13/351,350

(22) Filed: Jan. 17, 2012

Related U.S. Application Data
(63) Continuation of application No. 12/019,870, filed on Jan. 25, 2008.

(30) Foreign Application Priority Data
Mar. 29, 2007 (JP) 2007-086319
Aug. 2, 2007 (JP) 2007-201443

(51) Int. Cl. C09D 7/12

(52) U.S. Cl. 106/287.18

(57) ABSTRACT

A conventional method for forming an insulating film on a magnet has a difficulty in achieving sufficient improvement in magnetic characteristics due to nonuniformity of a coating film, and an extended time and higher temperature which are required in a thermal treatment. In order to solve the problems, the present invention provides a treating solution composed of an alcohol based solvent and a rare earth fluoride or alkaline earth metal fluoride dispersing in the solvent. In the treating solution, at least one X-ray diffraction peak has a half-value width larger than 1°. The present invention also provides a method for forming an insulating film using the treating solution.

### CROSS-REFERENCE TO RELATED APPLICATION

This application is a continuation application of U.S. application Ser. No. 12/019,870, filed Jan. 25, 2008, the contents of which are incorporated herein by reference.

### BACKGROUND OF THE INVENTION

1. Field of the Invention

The present invention relates to a treating solution for forming a fluoride coating film on a magnetic material, and to a method for forming a fluoride coating film on a magnetic material.

2. Background Art

In recent years, techniques for forming a fluoride insulating film on the surface of a magnetic material have been developed in order to improve characteristics of the magnet. Publicly available documents describing the insulating film formation include: Japanese Patent Application Laid-open Publications No. 2006-66853 (JP-A 2006-66853); No. 2006-66870 (JP-A 2006-66870); No. 2006-233277 (JP-A 2006-233277); No. 2006-238604 (JP-A 2006-238604); and No. 2006-283042 (JP-A 2006-283042).

JP-A 2006-66853 describes that a film composed primarily of a crystalline or amorphous fluoride is formed on the surface of a NdFeB-based magnet powder using a solution including a fluoride, and that the fluoride or an oxygen-fluoride formed in further reaction has a thickness of 1 nm to 100 nm in a layer form. Improved magnetic characteristics, such as an increased coercive force, a decreased temperature coefficient of the coercive force, and an increased Hk (anisotropic field), as well as enhanced resistivity are described in addition to the usage of gelled NdF₃.

JP-A 2006-66870 describes that a magnetic powder or a sintered body is coated with a gel, and then heated for formation of a fluorine compound.

JP-A 2006-233277 describes that, when a film composed primarily of a fluorine compound is formed on the surface of a magnetic material using a gelled fluorine compound, the fluorine compound having a grain size ranging from 1 nm to 20 nm grows, and a diffusion reaction occurs between the fluorine compound and the magnetic material.

JP-A 2006-238604 describes the formation of a layer containing fluorine using a sol solution, explains that the structure of a fluorine compound on the surface of a NdFeB-based magnetic material changes from REF₃ to REF₂ due to a thermal treatment, and shows an application to a permanent-magnet rotating machinery.

JP-A 2006-283042 describes a treating solution in which a rare-earth fluoride or alkaline earth metal fluoride is swollen in an alcohol based solvent, and in which the gelled rare-earth fluoride or alkaline earth metal fluoride is dispersed in the alcohol based solvent. It is also described that it is possible to apply the treating solution on the surface of a NdFeB sintered body, and to improve magnetic and electric characteristics and reliability.

### SUMMARY OF THE INVENTION

For a technique of forming a fluoride insulating film on the surface of a magnetic material, it is necessary to investigate an optimal coating solution (treating solution) to form a fluoride coating film for various purposes, such as achieving uniformity of a coating film, lowering temperature of the reaction with a mother phase after the coating, and shortening the amount of time required for a thermal treatment.

In the above-mentioned patent documents, a fluoride insulating layer is formed using either a solution including a fluoride, a gelled fluorine compound, or a sol solution; however, these documents provide no description regarding the structure of the treating solution. Although JP-A 2006-283042 provides a description of the treating solution, no investigation was conducted to obtain suitable conditions for forming an insulating film, such as an interatomic distance and plane distance of the main component of the solution. Therefore, the conventional techniques of forming a fluoride insulating film have a difficulty in sufficiently improving the magnetic characteristics due to some technical drawbacks, such as nonuniformity of a coating film, and an extended period of time and high temperature which are required in the thermal treatment.

The present invention has been made in view of such a difficulty, an object of the present invention is to provide a treating solution and a method for forming a fluoride coating film which allow continuous formation of a layer containing fluorine having an appropriate thickness at a lower temperature than that in the processes in the conventional techniques.

The present invention adopts a treating solution including a rare-earth fluoride or an alkaline earth metal fluoride in a sol form dispersed in an alcohol based solvent. Since the fluorine compound solution comes in surface contact with the surface of an object to be treated, the present invention has the following advantages over a case of using a ground fluorine compound powder: that is, a reaction with the fluorine compound at a low temperature, a reduced use of fluorine compound, an improved coating uniformity, and an increased diffusion distance. Having these advantages, the present invention is capable of causing diffusion of the fluorine or a rare earth element at a low temperature.

One of the features of the present invention is using a treating solution for forming a fluoride coating film composing a rare earth fluoride or an alkaline earth metal fluoride, which is swollen in an alcohol based solvent and therefore in a sol form, dispersing in the alcohol based solvent. Another one of the features is adopting the following method for a fluoride coating film formation. The method is for forming a rare earth fluoride coating film or an alkaline earth metal fluoride coating film on an object to be film coated. The method having a process of mixing the object to be coated in an alcohol based solvent including a rare earth fluoride or an alkaline earth metal fluoride which is swollen therein and in a sol form, and which is ground to have an average grain size of 10 μm or smaller causes a distribution in plane distances reflecting the structure of constituent elements, and thereby causes the rare earth fluoride coating film or the alkaline earth metal fluoride coating film to have a more distributed periodic structure compared to a crystalline structure of fluorine compound composed of fluorine and any one of a rare earth element and an alkaline earth element.

The specific configurations of the present invention are described below. The treating solution which is composed of an alcohol based solvent, and a rare earth fluoride or an alkaline earth metal fluoride dispersing in the solvent. In the treating solution, at least one of the peaks observed in an X-ray diffraction profile has a half-value width larger than 1°. The treating solution includes the rare earth fluoride or the alkaline earth metal fluoride in a sol form or a gel form dispersing in the solvent. The concentration of the rare earth fluoride or alkaline earth metal fluoride in the solvent is in a range from 0.1 g/dm³ to 100 g/dm³ inclusive. The rare earth element and alkaline earth metal element in the treating solution includes at least one selected from the group consisting of La, Ce, Pr, Nd, Sm, Eu, Gd, Tb, Dy, Ho, Er, Tm, Yb, Lu, Mg, Ca, Sr, and Ba. The alcohol in the treating solution includes at least one selected from the group consisting of methyl alcohol, ethyl alcohol, n-propyl alcohol, and isopropyl alcohol. The alcohol based solvent includes at least one selected from the group consisting of methyl alcohol, ethyl alcohol, n-propyl alcohol, and isopropyl alcohol in a concentration range from 50 wt % to less than 100 wt % and at least one selected from the group consisting of acetone, methyl ethyl ketone, and methyl isobutyl ketone in a concentration range from above 0 wt % to 50 wt %.

In the treating solution, the multiple peaks are observed in an X-ray diffraction profile, and each of the peaks is observed to have a diffraction angle corresponding to a range of plane distance from 1.0 angstrom to 4.5 angstroms inclusive. In the treating solution, the rare earth fluoride or the alkaline earth metal fluoride is in a sol form, and is dispersing in the solvent. In the treating solution, the multiple peaks are observed in the X-ray diffraction profile, and each of the peaks has a half-value width larger than 1°. In the treating solution, the peak structure obtained in the X-ray diffraction profile is different from that of a fluorine compound expressed by REₙFₘ (RE represents a rare earth element or alkaline earth element; F represents fluorine; n and m represent positive integers) or of an oxygen-fluorine compound which is the fluorine compound containing oxygen.

Other features and configurations of the present invention will be described in Detailed Description of the Preferred Embodiments section below.

The treating solution and the method for forming a fluoride coating film according to the present invention enable continuous formation of a layer containing fluorine having an appropriate thickness.

This specification incorporates the content of the specification of Japanese Patent Application No. 2007-086319 and Japanese Patent Application No. 2007-201443, for which priority is claimed to the present application.

### BRIEF DESCRIPTION OF THE DRAWINGS

FIG. 1 is process drawing.

FIG. 2 is process drawings.

FIG. 3 shows the coating of a bulk body.

FIG. 4 shows the coating of a ring compact.

FIG. 5 shows an example of an X-ray diffraction pattern.

FIG. 6 is a transmission electron microscope photograph.

FIG. 7 shows an EDX profile.

FIG. 8 shows images obtained in an element analysis.

### DETAILED DESCRIPTION OF THE PREFERRED EMBODIMENTS

The present invention is capable of improving a coercive force, increasing a squareness of a B—H loop in the second quadrant, and, as a result, improving energy product in an R—Fe—B-based (R represents a rare earth element) or R—Co-based magnet. Moreover, a highly water resistant coating film is provided on the surface of metal or metal oxide of a magnet produced according to the present invention, and thereby the present invention is capable of enhancing corrosion resistance, and also capable of reducing an eddy current loss by providing an insulating coating film on the magnet powder surface. Being able to withstand temperature of 600° C. or higher, the coating film of the present invention allows a powder magnetic core to be annealed, and thereby can reduce a hysteresis loss. A magnet powder for a rare earth magnet or a soft magnetic powder with the coating film of the present invention thereon is used to prepare a rare earth magnet or powder magnetic core. Then, the rare earth magnet or powder magnetic core becomes capable of inhibiting an eddy current loss and a hysteresis loss occurring upon being exposed to a fluctuating magnetic field, such as an AC magnetic field, and thereby capable of reducing heat generation associated with the eddy current loss and hysteresis loss. Therefore, such a rare earth magnet and powder magnetic core can be used in rotating machinery, such as a surface magnet motor and an embedded magnet motor, and devices, such as an MRI and a current-limiting device, in which a magnet and/or a magnet core are placed within a high-frequency magnetic field.

In order to achieve the above-described object, it is necessary to form a layer including a near-grain boundary layer having a concentration gradient of a metal fluoride, or a fluoride containing oxygen or carbon, fluorine, and rare earth element while maintaining the magnetic characteristics along the grain boundary or the powder surface. In the case of a NdFeB magnet, having Nd₂Fe₁₄B in the main phase, the phase diagram shows the presence of a Nd phase and a Nd_{1.1}Fe₄B₄ phase. When the NdFeB magnet is heated after an appropriate composition of NdFeB is acquired, a Nd phase or a NdFe-alloy phase can be formed in a grain boundary. Since this phase containing a high concentration level of Nd is susceptible to oxidation, an oxidized layer is formed in a part of the phase. A layer containing fluorine is formed on the outside of the main phase of the Nd phase, NdFe-alloy layer or Nd oxidized layer, in a view from the core of the grain. The layer containing fluorine has an atom pair of fluorine bonded with at least one of alkaline earth metal elements and rare earth elements. The layer containing fluorine is formed to be in contact with the Nd₂Fe₁₄B-Nd phase, NdFe phase, or Nd oxidized layer. Having the melting temperature lower than that of the Nd₂Fe₁₄B phase, the Nd phase or the NdFe phase is easier to diffuse upon being heated, resulting in the alternation of the organization and structure thereof. It is more important to increase the average thickness of the layer containing fluorine bonded with the alkaline earth metal element or rare earth element, the portion having the fluoride concentration gradient, or the portion having the rare earth element concentration gradient, than the thickness of the Nd phase, the NdFe phase, or the Nd oxidized layer. By adjusting the thickness in this way, it is possible to reduce a loss of eddy currents or to improve the magnetic characteristics. A ferromagnetic material powder, such as a NdFeB-based magnetic powder, containing at least one of rare earth elements is susceptible to oxidation due to the rare earth element contained therein. An oxidized powder is used to produce a magnet in some cases to make the handling of powder easier. The larger the thickness of such an oxidized layer, the lower the stability of the layer containing a fluoride as well as the magnetic characteristics. With a thicker oxidized layer, a structural change is observed in the layer containing a fluoride in a thermal treatment applying temperature of 400° C. or higher. Diffusion and alloying between the layer containing a fluoride and the oxidized layer (diffusion and alloying of the fluoride and oxide) occur.

Next, materials which can be adopted in the present invention will be described. For a layer containing a fluoride, the following materials can be adopted: fluorides such as CaF₂, MgF₂, SrF₂, BaF₂, LaF₃, CeF₃, PrF₃, NdF₃, SmF₃, EuF₃, GdF₃, TbF₃, DyF₃, HoF₃, ErF₃, TmF₃, YbF₃, and LuF₃; amorphous materials having these fluoride compositions; fluorides composed of multiple elements which form these fluorides; complex fluorides composed of any of the fluorides listed above mixed with oxygen, nitrogen, or carbon; fluorides composed of the fluoride listed above mixed with constituent elements, with an impurity, included in a main phase; and fluorides having fluorine concentration lower than those of the fluorides listed above. In order to produce a layer containing any of these fluorides uniformly on the surface of a ferromagnetic powder, it is effective to adopt a coating method utilizing a solution. For a magnetic powder for a rare earth magnet which is extremely susceptible to corrosion, a spattering method and a vapor-deposition method are available for a metal fluoride formation; however, it is labor intensive and expensive to make the thickness of the metal fluoride uniform in these methods. In the meantime, a wet method which utilizes a solution is not desirable for the reason that a magnet powder for a rare earth magnet easily produces a rare earth oxide during the process. It has been discovered that the present invention is capable of preventing the corrosion of a magnetic powder for a rare earth magnet, and also capable of coating a metal fluoride, by adopting a solution consisting primarily of alcohol, which has high wettability to a magnetic powder for a rare earth magnet, and which can eliminate ion components from the solution as much as possible.

Regarding the state of a metal fluoride, it is not desirable to have a solid form according to the purpose of coating the metal fluoride on a magnetic powder for a rare earth magnet. This is because the application of a metal fluoride in a solid form on a magnetic powder for a rare earth magnet does not result in the formation of a continuous metal fluoride film on the surface of the magnetic powder. In the present invention, upon focusing on the phenomena that a sol-gel reaction occurs when hydrofluoric acid (hereafter referred to as HF) is added to a solution containing rare earth and alkaline earth metal ions, it has been discovered that ion components can also be removed from the solution at the same time when the solvent, water in this case, is replaced with alcohol. Furthermore, it has been discovered that the gelled metal fluoride can be transformed to a sol by applying ultrasonic stirring in the process, and therefore it is possible to obtain an optimal treating solution for forming a uniform metal fluoride film on the surface of a magnetic powder for a rare earth magnet. The structure of the metal fluoride in a sol or solution form, unlike the crystal structure of rare earth fluorine compounds, alkali earth metal fluorine compounds, and the like, has a feature of having broad diffraction peaks. This is because the fluorine and metal element are swollen in a solvent, such as alcohol. The periodic structure of the interatomic distance between the metal element and fluorine is wider than that of the crystal structure. The solution containing such a gel has optical transparency and can be caused to have lower viscosity; thus, the following advantages are expected: 1) it is possible to perform a treatment along a wall surface having microcracks and micropores; 2) it is possible to perform a treatment along a nonuniform powder surface; 3) being capable of providing a coating film having a uniform thickness on the substrate surface, the solution can be used for various wafer processes (various patterning processes); 4) it is possible to obtain better uniformity in film thickness than that in a coating treatment with powders; 5) a diffusion reaction can progress at a lower temperature than that in a coating treatment with powders; 6) it is possible to control the ratio of concentration between metal element and fluorine; 7) it is possible to prepare a solution containing various powders mixed therein, and to use the solution for coating; 8) a diffusion length can be extended because the reaction can progress at a lower temperature than that in a coating treatment with powders; 9) a reduction reaction can progress at a lower temperature; 10) using no powder, the solution can be adopted in a process requiring a clean environment; 11) it is easy to control a coating film thickness at the level of nm; therefore, it is possible to provide a coating using different kinds of fluorine compound solutions or a solution mixed with minute powders; 12) it is possible to provide a coating in the amount required for diffusion by controlling the film thickness; thus, high utilization efficiency of coating materials is achieved; and 13) it is possible to form a coated magnetic material by mixing the solution with magnetic powders or magnetic particles.

The layer containing a metal fluoride can be formed either before or after a thermal treatment for providing a high level of coercive force after sintering. After having the surface of a magnetic powder for a rare earth magnet being covered with the layer containing the fluoride, the orientation of the magnetic powder can be aligned in the magnetic field, and then the magnetic powder is subjected to a hot molding process to obtain an anisotropic magnet. It is also possible to prepare an isotropic magnet by applying no magnetic field for providing anisotropy. Moreover, after being heated at 1200° C. or lower for acquisition of a high level of coercive force, the magnetic powder for a rare earth magnet covered with a layer containing a fluoride can be mixed with an organic material to prepare a compound for a bonded magnet. Ferromagnetic materials containing a rare earth element which can be used in the present invention include: a material having a NdFeB-based magnetic material, such as Nd₂Fe₁₄B, (Nd, Dy)₂Fe₁₄B, Nd₂(Fe, Co)₁₄B, and (Nd, Dy)₂(Fe, Co)₁₄B, in a main phase; a powder of the NdFeB-based magnetic materials with Ga, Mo, V, Cu, Zr, Tb, Pr, Nb, or Ti; a Sm₂Co₁₇-based material, such as Sm₂ (Co, Fe, Cu, Zr)₁₇ or Sm₂Fe₁₇N₃; and the like. In the present invention, the rare earth fluoride, transition-metal fluoride, or alkaline earth metal fluoride in the treating solution for forming a coating film is swollen in the alcohol based solvent. This is because it has been revealed that a rare earth fluoride gel or an alkaline earth metal fluoride gel has a flexible gelatin-like structure, and that alcohol has excellent wettability to a magnetic powder for a rare earth magnet. By adopting the alcohol based solvent, it is possible to prevent the oxidization of the magnetic powder for a rare earth magnet which is extremely susceptible to oxidation.

Meanwhile, in the case where water is added as a solvent to the treating solution for forming a rare earth fluoride coating film, it is preferable that the solvent be replaced with alcohol in advance. This is because the removal of ionic components as impurities can prevent the oxidization of the magnetic powder for a rare earth magnet. Incidentally, water is added to the treating solution for forming a rare earth fluoride coating film when the rare earth fluoride can be turned into a gelatin-like gel more easily, since the rare earth element in the rare earth fluoride may contain water. In the case where the conditions for the thermal treatment facilitate susceptibility to oxidation of a magnetic powder for a rare earth magnet, the addition of a benzotriazole-based organic anti-rust agent is effective.

A concentration of the rare earth fluoride or alkaline earth metal fluoride depends on the thickness of a film formed on the surface of a magnetic powder for a rare earth magnet. There is an upper limit for the concentration in order to maintain the state where the rare earth fluoride or alkaline earth metal fluoride is swollen in the alcohol based solvent, and where the rare earth fluoride or alkaline earth metal fluoride in a sol form is dispersing in the alcohol based solvent. The upper limit of the concentration will be described below. In order to obtain a treating solution in which the rare earth fluoride or alkaline earth metal fluoride is swollen and dispersing in the alcohol based solvent, it is preferable that the concentration of the rare earth fluoride or alkaline earth metal fluoride in the treating solution be in a range from 0.1 g/dm³ to 100 g/dm³ inclusive.

Furthermore, the rare earth element or alkaline earth metal element in the treating solution may include at least one selected from the group consisting of La, Ce, Pr, Nd, Sm, Eu, Gd, Tb, Dy, Ho, Er, Tm, Yb, Lu, Mg, Ca, Sr, and Ba.

The alcohol used in the treating solution may include at least one selected from the group consisting of methyl alcohol, ethyl alcohol, n-propyl alcohol, and isopropyl alcohol. The alcohol based solvent may include at least one selected from the group consisting of methyl alcohol, ethyl alcohol, n-propyl alcohol, and isopropyl alcohol in a concentration range from 50 wt % to less than 100 wt %, and at least one selected from the group consisting of acetone, methyl ethyl ketone, and methyl isobutyl ketone in a concentration range from above 0 wt % to 50 wt %.

The adding amount of the treating solution for forming a rare earth fluoride coating film depends on an average grain size of a magnetic powder for a rare earth magnet. When the average grain size of a magnetic powder for a rare earth magnet is in a range from 0.1 μm to 500 μm inclusive, it is preferable that the amount be in a range from 10 ml to 300 ml per 1 kg of the magnetic powder for a rare earth magnet. This is because an excessive amount of the treating solution not only causes time for removing the solvent to extend, but also causes the magnetic powder for a rare earth magnet to be more susceptible to corrosion. An insufficient amount of the treating solution, on the other hand, causes some parts of the surface of the magnetic powder for a rare earth magnet not to be wet by the treating solution.

The present invention can be used for all the Fe-based, Co-based, and Ni-based magnetic materials, such as Nd—Fe—B-based, Sm—Fe—N-based, and Sm—Co-based materials containing a rare earth element as a material of the rare earth magnet.

The present invention will be further described specifically by referring to examples.

### EXAMPLE 1

A treating solution for forming a rare earth fluoride or alkaline earth metal fluoride coating film was prepared according to the following steps.
(1) 4 g of salt having a high solubility to water, such as lanthanum acetate or lanthanum nitrate for La, was added to 100 ml of water, and dissolved completely using a shaker or an ultrasonic stirrer.
(2) HF diluted to 10% was gradually added in an equivalent amount for a chemical reaction to generate LaF₃.
(3) The solution in which a gelled precipitation of LaF₃ was generated was stirred for 1 hour or longer using an ultrasonic stirrer.
(4) After the solution was centrifuged at a speed ranging from 4,000 to 6,000 rpm, the supernatant was removed, and methanol was added at an amount approximately equivalent to the removed supernatant.
(5) After the methanol solution containing gelled LaF₃ was stirred thoroughly to obtain a suspension, the suspension was stirred with an ultrasonic stirrer for one hour or longer.
(6) The steps (4) and (5) were repeated three to ten times until no anion, such as acetate ion and nitrate ion, was detected.
(7) In the end, in the case of LaF₃, almost transparent LaF₃ in a sol form was obtained. The methanol solution containing 1 g of LaF₃ per 5 ml of the solution was adopted as the treating solution.

The other treating solutions used for forming a rare earth fluoride or alkaline earth metal fluoride coating film are summarized in Table 1 below.

TABLE 1

| Constituent | Half- | Half-value | Main phase |
|---|---|---|---|
| element of | value | width in | formed |
| fluorine | width | coating | after thermal |
| compound solution | in gel | film | treatment |
| Li | 6.4 | 5.8 | LiF₃, LiF₂, Li(O, F) |
| Mg | 6.2 | 5.2 | MgF₂, Mg(O, F) |
| Ca | 6.1 | 4.5 | CaF₂ |
| La | 5.9 | 4.1 | LaF₃, LiF₂ |
| Ce | 6.8 | 3.9 | CeF₃, CeF₂ |
| Pr | 6.9 | 6.1 | PrF₃, Pr₂F₂ |
| Nd | 7.3 | 5.7 | NdF₃, NdF₂, Nd(OF) |
| Sm | 6.5 | 5.1 | SmF₃, SmF₂ |
| Eu | 6.5 | 4.5 | EuF₂, EuF_{2.55} |
| Gd | 6.2 | 4.2 | GdF₃ |
| Tb | 6.0 | 5.6 | TbF₃, TbF₂, Tb(OF) |
| Dy | 6.3 | 6.1 | DyF₃, Dy(OF) |
| Ho | 4.5 | 3.6 | HoF₃, Ho(OF) |
| Er | 3.8 | 3.5 | ErF₃ |
| Tm | 5.2 | 3.5 | TmF₃ |
| Yb | 4.1 | 2.5 | YbF₂, YbF_{2.37} |
| Lu | 3.3 | 1.4 | LuF₃ |

Table 1 describes each metal used in the treating solution (each constituent element of the fluorine compound solution) in terms of half-value width of an X-ray diffraction peak in the treating solution (half-value width in a gel), half-value width of an X-ray diffraction peak after the coating on an object to be insulated (half-value width in a coating film), and insulator obtained by a thermal treatment after the coating on the object to be insulated (main phase formed after thermal treatment).

With a CuKα radiation as the X-ray source, a diffraction pattern was measured by using an appropriate slit by 0-20 scanning. Plane distance was obtained on the basis of the obtained peak value in the diffraction pattern, and then a half-value width of diffraction peaks was obtained.

As a result, it was revealed that the treating solution composed of any of the rare earth elements and alkaline earth metal elements exhibited the X-ray diffraction pattern different from that of a fluorine compound expressed as REₙFₘ (RE represents a rare earth element or an alkaline earth metal element; n and m represent positive integers) or that of an oxygen-fluorine compound, when the above-described steps were followed. It was also observed that the diffraction pattern had multiple peaks each having a half-value width of 1° or larger. This also indicated that the treating solution was different from REₙFₘ in terms of an interatomic distance between the metal element and fluoride or between the metal elements, and also in terms of crystalline structure. Since the half-value width was 1° or larger, the interatomic distance of the treating solution had a certain distribution, unlike a normal metal crystal having a constant interatomic distance. Such a distribution was caused by the presence of other atoms, mainly of hydrogen, carbon, and oxygen, located around the metal element or fluoride element atom. The application of an external energy, such as heat, caused these atoms, such as hydrogen, carbon, and oxygen, to easily migrate, and thereby changed the structure and fluidity. X-ray patterns of the sol and gel, whose peak had a half-value width larger than 1°, exhibited a structural change by a thermal treatment, and further exhibited a part of a diffraction pattern of the REₙFₘ or REₙ(F, O)ₘ. The diffraction peak of the REₙFₘ had a narrower half-value width than that of the diffraction peak of the sol or gel. In order to obtain a coating film having a uniform thickness by increasing the fluidity of the solution, it is important to have at least one diffraction peak having a half-value width of 1° or larger in the diffraction pattern of the solution. Such a peak having a half-value width of 1° or larger, and the diffraction pattern of the REₙFₘ or a peak of an oxygen-fluorine compound may also be included in the diffraction pattern of the solution. In the case where only the diffraction pattern of the REₙFₘ or the oxygen-fluorine compound including oxygen was observed, or where a diffraction pattern having 1° or smaller was observed, mainly in the diffraction pattern of the solution, it was difficult to provide a uniform coating due to poor fluidity caused by the presence of solid phase, not in a sol or gel form, in the solution.

Next, a NdFeB alloy powder was used in the place of the magnetic powder for a rare earth magnet. The magnet powder had an average grain size of 100 μm, and was magnetically anisotropic. A rare earth fluoride or alkaline earth metal fluoride coating film was formed on the magnetic powder for a rare earth magnet in the following steps.

In a NdF₃ coating film formation process, a semi-transparent sol solution containing 1 g of NdF₃ per 10 mL of the solution was prepared.
(1) To 100 g of the magnetic powder for a rare earth magnet having an average grain size of 70 μm, 15 ml of the treating solution for forming a NdF₃ coating film was added, and the mixture was mixed until the entire magnetic powder for a rare earth magnet was observed to be wet.
(2) The magnetic powder for a rare earth magnet mixed with the treating solution for forming a NdF₃ coating film prepared in the step (1) was placed under a reduced pressure of 2 to 5 Torr for removal of the solvent methanol.
(3) The magnetic powder for a rare earth magnet in which the solvent was removed in the step (2) was transferred to a quartz boat, and heat-treated under a reduced pressure of 1×10⁻⁵ Torr at 200° C. for 30 minutes and at 400° C. for 30 minutes.
(4) The magnetic powder heat-treated in the step (3) was transferred to a container made from Macor® with a lid (manufactured by Riken Denshi Co., Ltd.), and heat-treated under a reduced pressure of 1×10⁻⁵ Torr at 800° C. for 30 minutes.
(5) Magnetic characteristics of the magnetic powder for a rare earth magnet heat-treated in the step (4) were examined.
(6) The magnetic powder for a rare earth magnet heat-treated in the step (4) was mounted in a metal mold. The orientation of the magnetic powder was aligned in a magnetic field of 10 kOe under an inert gas atmosphere, and the magnetic powder was shaped by hot compression molding with a molding pressure of 5 t/cm². Under a molding condition of 700° C., an anisotropic magnet having a size of 7 mm×7 mm×5 mm was prepared.
(7) A pulsed magnetic field of 30 kOe or stronger was applied to the anisotropic magnet prepared in the step (6) in the anisotropy direction. Magnetic characteristics of the magnet were examined

Magnetic characteristics of magnets made of magnetic powders having other rare earth fluoride or alkaline earth metal fluoride coating films formed thereon, which were prepared in the process including the above-described steps (1) to (7) were examined

The result revealed that the magnetic powders provided with the various rare earth fluoride or alkaline earth metal fluoride coating films formed thereon and the anisotropic rare earth magnets made of the magnetic powders had improved magnetic characteristics and large specific resistances compared to a magnetic powder having no coating film and an anisotropic rare earth magnet made of the magnetic powder. It was confirmed, particularly, that the magnetic powders having TbF₃ and DyF₃ coating films respectively formed thereon and the anisotropic rare earth magnets made of the respective magnetic powders had largely improved magnetic characteristics, and that anisotropic rare earth magnets made of the magnetic powders provided with the LaF₃, CeF₃, PrF₃, NdF₃, TmF₃, YbF₃, and LuF₃ coating films respectively formed thereon had largely increased specific resistances.

### EXAMPLE 2

A treating solution for forming a rare earth fluoride or alkaline earth metal fluoride coating film prepared in the steps shown in Example 1 was used. There were very few diffraction peaks identified as REₙFₘ in the X-ray diffraction pattern of the solution, and the main diffraction peaks detected had half-value widths ranging from 2° to 10°. Hence, it was suggested that there was little solid phase having poor fluidity in the solution. Table 1 shows the half-value widths of the gels used for the fluorine compound solutions, and the half-value widths of the X-ray diffraction peaks while the gels were coated on the surfaces of NdFeBs. All the diffraction peaks of the gels and the coated films shown in the table have a half-value width larger than 1°; thus, it was indicated that the peaks have a pattern similar to that of the amorphous. The magnetic powder for a rare earth magnet used in this example was prepared by grinding a NdFeB-based amorphous ribbon to powders, the ribbon having been prepared by rapidly cooling a mother alloy having the adjusted composition. To be more specific, in a process utilizing a roll, such as single-roll and twin-roll processes, the mother alloy was melted on the surface of a rotating roll, and was sprayed using an inert gas, such as an argon gas, for rapid cooling. The rapid cooling process was conducted under either an inert gas atmosphere, reduced atmosphere, or vacuum atmosphere. The rapidly-cooled ribbon thus obtained was amorphous or a material in amorphous-crystalline mixed state. The ribbon was ground to powders having an average grain size of 300 μm, and then the particles thus obtained were classified. The magnetic powder containing the amorphous material became a magnetic powder having a Nd₂Fe₁₄B main phase by being heat-treated for the crystallization.

A rare earth fluoride or alkaline earth metal fluoride coating film was formed on the magnetic powder for a rare earth magnet in the following steps.

In a LaF₃ coating film formation process, a semi-transparent sol solution containing 5 g of LaF₃ per 10 mL of the solution was prepared.
(1) To 100 g of the magnetic powder for a rare earth magnet having an average grain size of 300 μm, 5 ml of the treating solution for forming a LaF₃ coating film was added, and the mixture was mixed until the entire magnetic powder for a rare earth magnet was observed to be wet.
(2) The magnetic powder for a rare earth magnet mixed with the treating solution for forming a LaF₃ coating film prepared in the step (1) was placed under a reduced pressure of 2 to 5 Torr for removal of the solvent methanol.
(3) The magnetic powder for a rare earth magnet in which the solvent was removed in the step (2) was transferred to a quartz boat, and heat-treated under a reduced pressure of 1×10⁻⁵ Torr at 200° C. for 30 minutes and at 400° C. for 30 minutes.
(4) The magnetic powder heat-treated in the step (3) was transferred to a container made from Macor® with a lid (manufactured by Riken Denshi Co., Ltd.), and heat-treated under a reduced pressure of 1×10⁻⁵ Torr at 800° C. for 30 minutes.
(5) Magnetic characteristics of the magnetic powder for a rare earth magnet heat-treated in the step (4) were examined.
(6) The magnetic powder for a rare earth magnet heat-treated in the step (4) was mixed with 10% by volume of a solid epoxy resin (EPX6136 manufactured by Somar Corporation) having a size of 100 μm or smaller using a V-shape mixer.
(7) The compound of the magnetic powder for a rare earth magnet and the resin prepared in the step (6) was mounted in a metal mold, the orientation of the compound was aligned in a magnetic field of 10 kOe under an inert gas atmosphere, and shaped by hot compression molding at 70° C. with a molding pressure of 5 t/cm². Then, a bonded magnet having a size of 7 mm×7 mm×5 mm was prepared.
(8) The bonded magnet prepared in the step (7) was incubated in nitrogen gas at 170° C. for one hour to harden the resin therein.
(9) A pulsed magnetic field of 30 kOe or stronger was applied to the bonded magnet prepared in the step (8). Magnetic characteristics of the magnet were examined

Magnetic characteristics of magnets made of magnetic powders having other rare earth fluoride or alkaline earth metal fluoride coating films formed thereon, which were prepared in the process including the above-described steps (1) to (9) were examined.

The result revealed that the rapidly-cooled magnetic powders provided with the various rare earth fluoride or alkaline earth metal fluoride coating films formed thereon and the bonded rare earth magnets made of the magnetic powders had improved magnetic characteristics and large specific resistances compared to a rapidly-cooled magnetic powder having no coating film and a bonded rare earth magnet made of the magnetic powder. It was confirmed, particularly, that the rapidly-cooled magnetic powders having TbF₃, DyF₃, HoF₃, ErF₃, and TmF₃ coating films respectively formed thereon and the bonded rare earth magnets made of the respective magnetic powders had largely improved magnetic characteristics, and that bonded rare earth magnets made of the rapidly-cooled magnetic powders having LaF₃, CeF₃, PrF₃, NdF₃, SmF₃, ErF₃, TmF₃, YbF₃, and LuF₃ coating films respectively formed thereon had largely increased specific resistances.

### EXAMPLE 3

Treating solutions for forming a rare earth fluoride or alkaline earth metal fluoride coating film used in this example were the CaF₂ and LaF₃ solutions prepared in the steps shown in Example 1. The concentration of the CaF₂ and LaF₃ solutions was 150 g/dm³. Soft magnetic powders used were: an iron powder having an average grain size of 60 μm; an Fe powder containing 7% of Si having an average grain size of 10 μm; an Fe powder containing 50% of Ni having an average grain size of 10 μm; an Fe powder containing 50% of Co having an average grain size of 30 μm; an Fe powder containing 10% of Si and 5% of Al having an average grain size of 20 μm; and an Fe powder containing 10% of Si and 10% of B having an average grain size of 20 μm.

Formation of a LaF₃ coating film will be described below.
(1) To 1 kg of the soft magnetic powder, 100 ml of the treating solution for forming a LaF₃ coating film was added, and the mixture was mixed until the entire magnetic powder for a rare earth magnet was observed to be wet.
(2) The soft magnetic powder mixed with the treating solution for forming a LaF₃ coating film prepared in the step (1) was placed under a reduced pressure of 2 to 5 Torr for removal of the solvent methanol.
(3) The soft magnetic powder in which the solvent was removed in the step (2) was transferred to a quartz boat, and heat-treated under a reduced pressure of 1×10⁻⁵ Torr at 200° C. for 30 minutes and at 400° C. for 30 minutes.
(4) The magnetic powder for a rare earth magnet heat-treated in the step (3) was mounted in a metal mold, and a molding pressure of 15 t/cm² was applied to prepare a ring-shape test piece for magnetic-characteristics evaluation having an external diameter of 28 mm, an internal diameter of 20 mm, and a thickness of 5 mm.
(5) The test piece prepared in the step (4) was annealed in nitrogen gas at 900° C. for 4 hours.
(6) Electric and magnetic characteristics of the test piece heat-treated in the step (5) were evaluated.

The result showed that it was possible to maintain a high level of specific resistance of the powder magnetic cores made of the various soft magnetic powders having the rare earth fluoride or alkaline earth metal fluoride coating films formed thereon, and treated in the annealing process, since the rare earth fluoride or alkaline earth metal fluoride coating film was highly resistant to heat. Thus, low values in both the eddy current loss and hysteresis loss were achieved, resulting in achieving a low value in the iron loss, which is a sum of these two values, of the powder magnetic core at individual frequencies.

### EXAMPLE 4

A NdFeB sintered body was prepared in the following steps. The raw materials, including Nd, Fe, and B, were provided by dissolving a Nd powder, Nd—Fe alloy powder, and Fe—B alloy powder, respectively, in vacuum or in an inert gas such as Ar with use of a device, such as a high-frequency induction device. If required, rare earth elements, such as Tb and Dy, may be added for increasing the coercive force. Other elements, such as Ti, Nb, and V, may be added for stabilizing the structure. Alternatively, Co may be added for enhancing corrosion resistance and magnetic characteristics. The dissolved mother alloy was coarsely crushed using a crusher, such as a stamp mill or a jaw crusher, ground using a grinder, such as a Braun mill, and then finely ground using a jet mill. The ground powder thus obtained was oriented in a magnetic field of 20 kOe or weaker such that an easy magnetic direction was aligned along the magnetic field, and was sintered while pressed with pressure from 0.1 t/cm² to 20 t/cm² under a reduced pressure or in an inert gas at a temperature from 400° C. to 1200° C. The molded sintered body having a size of 10 mm×10 mm×5 mm was magnetized in the anisotropic direction (the direction of 10 mm length side) up to a magnetization percentage of 95% or higher in a magnetic field of 20 kOe or stronger. The magnetization percentage was evaluated on the basis of the result from the measurement of the relationship between the magnetization magnetic field and the flux amount using a flux meter.

Treating solutions for forming a rare earth fluoride coating film used in this example were the LaF₃ and NdF₃ solutions prepared in the steps shown in Example 1. The concentration of LaF₃ and NdF₃ solutions was 1 g/dm³.
(1) A block of the NdFeB sintered body was impregnated into the treatment solution for forming a LaF₃ coating film, and the block was placed under a reduced pressure of 2 to 5 Torr for removal of the solvent methanol.
(2) The step (1) was repeated 5 times.
(3) A pulsed magnetic field of 30 kOe or stronger was applied to the anisotropic magnet with a surface coating film provided in the step (2) in the anisotropic direction.
(4) The anisotropic magnet prepared in the step (3) was evaluated by a salt-water spraying test or a PCT test under the following conditions.

Salt-water spraying test: 5% NaCl; 35° C.; 200 hours

PCT test: 120° C.; 2 atm; 100% RH; 1000 hours
(5) Magnetic characteristics of the magnet evaluated by the salt-water spraying test or the PCT test in the step (4) were examined

A demagnetization curve of the magnetized compact was measured by placing the compact between the magnetic poles of a DC M-H loop measurement device such that the magnetization direction of the compact agreed with the direction of the applied magnetic field, and then applying the magnetic field between the magnetic poles. The magnetic pole pieces for the application of the magnetic field to the magnetized compact were made of an Fe—Co alloy. The values of magnetization were corrected using a pure Ni sample and a pure Fe sample having the same shape. An AC magnetic field of 1 kOe having a frequency of 1 kHz was applied to the compact having a size of 10 mm×10 mm×5 mm by placing a magnet in a closed magnetic circuit and by connecting an AC source to a winding coil. Then, magnetic characteristics were evaluated.

In the result, the block of NdFeB sintered body having the rare earth fluoride coating film formed thereon showed no reduction in residual magnetic flux density, coercive force, and maximum energy product even after the salt-water spraying test or the PCT test. On the other hand, a block of NdFeB sintered body having no coating film formed thereon showed a significant reduction in magnetic characteristics, and, particularly after the salt-water spraying test, red rust was observed on the surface thereof. In the above example, the formation of a coating film on the surface of the magnetic powder was described. However, the treating solution for forming a coating film and the method for forming a coating film of the present invention can also be adopted to the coating of an insulating film on the surface of a semiconductor device substrate.

As described above, the magnetic powder, magnetic metal plate, and magnetic metal block have the surfaces provided with the coating film formed thereon, the coating film having a thickness ranging from 1 μm to 1 nm, using the rare earth fluoride or alkaline earth metal fluoride of the present invention. The magnetic powder, magnetic metal plate, and magnetic metal block are superior in magnetic characteristics, electric characteristics, and reliability compared to a magnetic powder, magnetic metal plate, and magnetic metal block having no coating film formed thereon.

### EXAMPLE 5

A rapidly-cooled powder mainly composed of Nd₂Fe₁₄B as the NdFeB-based powder was prepared, and a fluorine compound was formed on the surface of the powder. An optically transparent solution was prepared in the process showed in Example 1, and the solution was mixed with the NdFeB powder. The solvent in the mixture was evaporated and removed by heat. The coating film thus formed was examined in an X-ray diffraction (XRD) analysis. The analysis result showed that, if the heating was performed at temperature below 200° C., the half-value width of the X-ray diffraction peak was more than double of the width of a peak observed after a subsequent thermal treatment, and that broad peaks having a half-value width of 1° or larger were included in the X-ray diffraction profile of the coating film obtained as described above. Such broad peaks did not correspond to diffraction patterns of metal fluorine compounds and metal oxygen-fluorine compounds, such as the REₘFₙ. It was found that the crystalline structure of the fluorine compound film was changed by heating above 200° C., and that the film was made of DyF₃, DyF₂, DyOF, and the like. A magnetic powder having a residual magnetic flux density of 0.8 T or higher and provided with a high-resistive layer formed on the surface was obtained by heating the NdFeB-based magnetic powder having a grain size ranging from 1 μm to 300 μm at temperature below 800° C., which is the temperature of a thermal treatment to lower magnetic characteristics, while preventing oxidation of the magnetic powder. Having a grain size smaller than 1 μm, the powder became more susceptible to oxidization, and therefore the magnetic characteristics were prone to be deteriorated. In the case of the powder having a grain size larger than 300 μm, the level of enhancement of resistivity and other effects of fluorine compound formation, such as improvement in magnetic characteristics, became small. Regarding magnetic characteristics of the magnetic powder, the coercive force was increased by approximately 10% to 20% in a thermal treatment at temperature between 600° C. and 800° C.; thus, the magnetic powder became more resistant to demagnetization. The magnetic powder thus obtained had a residual magnetic flux density ranging from 0.8 T to 1.0 T and a coercive force ranging from 10 kOe to 20 kOe. The resistivity of the magnetic powder, which varies by the thickness of the fluorine compound coating film, could reach as high as a level of M (mega) Ω with the film thickness of 50 nm or above.

### EXAMPLE 6

A rapidly-cooled powder mainly composed of Nd₂Fe₁₄B as the NdFeB-based powder was prepared, and a fluorine compound was formed on the surface of the powder. For a formation of DyF₃ on the surface of the rapidly-cooled powder, Dy(CH₃COO)₃ as the raw material was dissolved in H₂O, and HF was added thereto. The addition of HF caused the formation of a gelatin-like DyF₃.XH₂O. This mixture was centrifuged to have the solvent removed. Having a concentration of the rare earth fluoride in a sol form of 10 g/dm³ or above, the treating solution exhibited a transmittance of 5% or above measured at a light path length of 1 cm at a wavelength of 700 nm. This optically transparent solution exhibited a broad X-ray diffraction peak having a half-value width ranging from 2° to 10°, and therefore having fluidity. This solution and the NdFeB powder were mixed. After the solvent of the mixture was evaporated, the hydration water therein was evaporated by heat. It was found that the crystalline structure of the fluorine compound film included a NdFe₃ structure, a NdF₂ structure, and the like by the thermal treatment at 500° C.

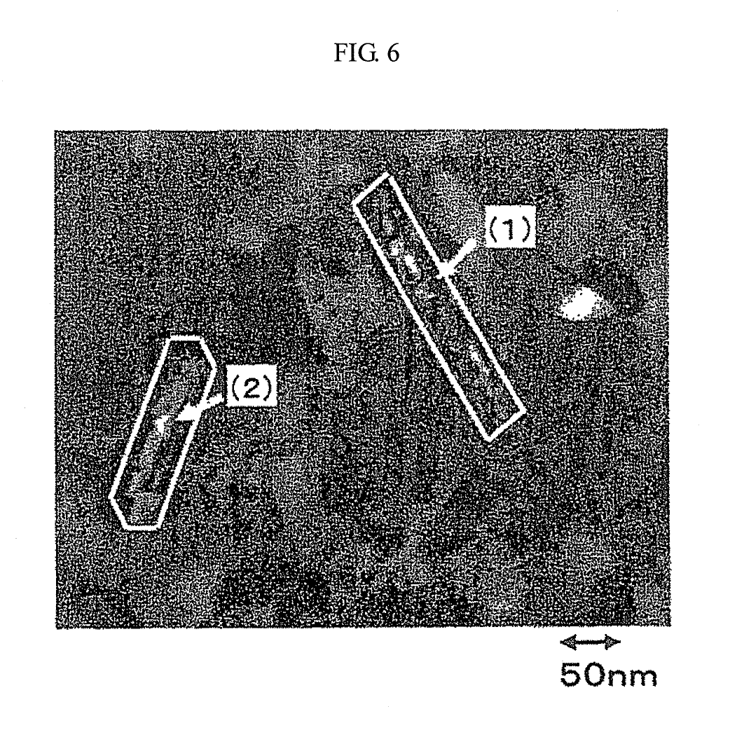

FIG. 6 shows a bright field image of a cross section of the magnetic powder after the thermal treatment in a transmission electron microscope observation. It was observed that the grain size of the mother phase was 50 nm or below, and the crystalline orientations were mostly random. Plate-like crystals larger than crystal grains of the mother phase were observed, and such crystals had shapes different from that of the mother phase, as indicated by arrows (1) and (2) in FIG. 6. The plate-like body indicated by the arrow (1) had a length of approximately 250 nm, and the one indicated by the arrow (2) had a length of approximately 150 nm, and was even larger than the grains of the mother phase (50 nm or smaller).

Observing contrasts even within the plate-like body, it was assumed that such contrasts were due to the plate-like body either having different orientations, being divided into crystal grains, or having distortions. As shown in FIG. 6, the plate-like bodies indicated by the arrows (1) and (2) were separated from each other by the crystal grains of the mother phase, thus not continuous, and did not grow throughout the grain boundary of the mother phase. Having the short axis ranging from approximately 20 nm to 50 nm, the plate-like body had a thickness equivalent to or smaller than that of the crystal grains of the mother phase. The plate-like bodies, having an axis ratio of the long axis over the short axis ranging from approximately 2 to 20, also existed in the center of the magnetic powder, growing in the crystal grain boundary of the mother phase or in the interior of the mother phase crystal grain. Contrasts were observed surrounding the plate-like bodies, suggesting the presence of lattice distortion between the plate-like bodies and the mother phase. These plate-like bodies were formed by parts of fluorine, rare earth elements, and the like, which diffused into the crystal grain boundary of the mother phase in the thermal treatment of the fluorine compound coated outside of the magnetic powder, and which reacted with the mother phase.

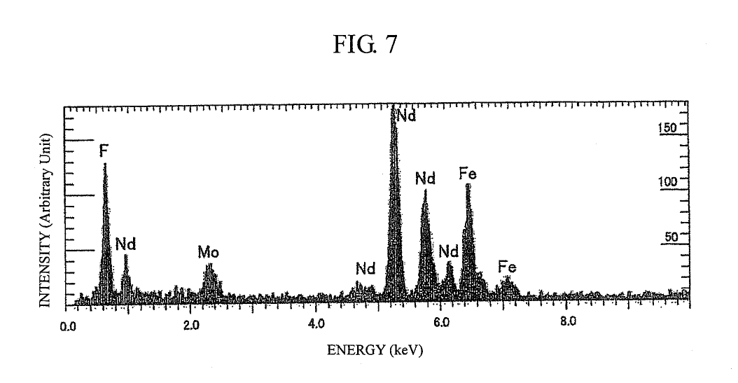

FIG. 7 shows an energy dispersive X-ray (EDX) profile of the site (radius of 10 nm) indicated by the arrow (1) in FIG. 6. Peaks representing fluorine (F), neodymium (Nd), iron (Fe), and molybdenum (Mo) were observed in the EDX. Mo was used in a sample mesh of the electron microscope, and therefore not involved in the magnet powder. Peaks derived from the sample represent 3 elements including F, Nd, and Fe. Among these 3 elements, Nd and Fe existed in the mother phase before the coating process. The ratio of Fe:Nd:F was 14:15:71. The ratio of the rare earth elements to fluorine was evaluated in various methods, and found to be ranging from 1:1 to 1:7. In some cases, peaks of oxygen and carbon were observed in the EDX profile including a peak of fluorine. Hence, it was assumed that the plate-like bodies indicated by the arrows (1) and (2) in FIG. 6 were made up with F, Nd, Dy, Fe, C, and O. Incidentally, no B was detected in the EDX analysis, and no detail is known regarding B; however, it is possible that some B diffused and existed with fluorine. Being any one of a fluorine compound, an oxygen-fluorine compound, and an oxygen-fluorine-carbon compound, the plate-like bodies indicated by the arrows (1) and (2) were mainly fluorine compounds containing oxygen as a part or oxygen-fluorine compounds containing fluorine as a part. While the plate-like bodies contained more Nd than Dy, a part of the diffusion path for formation of the plate-like body contained more Dy than the plate-like bodies contained. On the basis of the result, it was assumed that concentration distributions of the rare earth element, oxygen, and fluorine in the plate-like body or in the diffusion path for the plate-like body contributed to the increase of the coercive force. To be more specific, according to the segregation of Dy and Nd in the diffusion path in which the plate-like bodies were formed, and the segregation of Nd, Dy, and fluorine in the plate-like bodies, it was assumed that the increase of an anisotropic energy, the improvement of lattice matching in the grain boundary, and the reduction reaction of the mother phase by fluorine contributed to the improvement in magnetic characteristics.

### EXAMPLE 7

A treating solution for forming a rare earth fluoride or alkaline earth metal fluoride coating film was prepared by dissolving rare earth acetate or alkaline earth metal acetate in water, and then gradually adding diluted HF to the solution. The solution in which a gelled precipitation of fluorine compound, oxygen-fluorine compound, or oxygen-fluorine carbide had been generated was stirred using an ultrasonic stirrer. After the solution was centrifuged, methanol was added. The methanol solution in a gel form was stirred, and caused the solution to acquire transparency by removing anions. In the treating solution thus obtained, the anions were removed to achieve a transmittance of 5% or higher measured in a range of visible light. It was observed that the X-ray diffraction pattern of the treating solution included multiple diffraction peaks having half-value widths of 1° or larger. The solution was coated on a magnetic powder, and then the solvent was removed. A rapidly-cooled NdFeB-based powder having Nd₂Fe₁₄B as the main structure was prepared, and a Dy-fluorine compound was formed on the surface of the powder. After the optically transparent solution was mixed with the NdFeB powder, the solvent in the mixture was evaporated. It was found that the crystalline structure of the fluorine compound film became a NdFe₃ structure, a NdF₂ structure, and the like by a thermal treatment at 200° C. to 700° C. and the subsequent rapid cooling treatment.

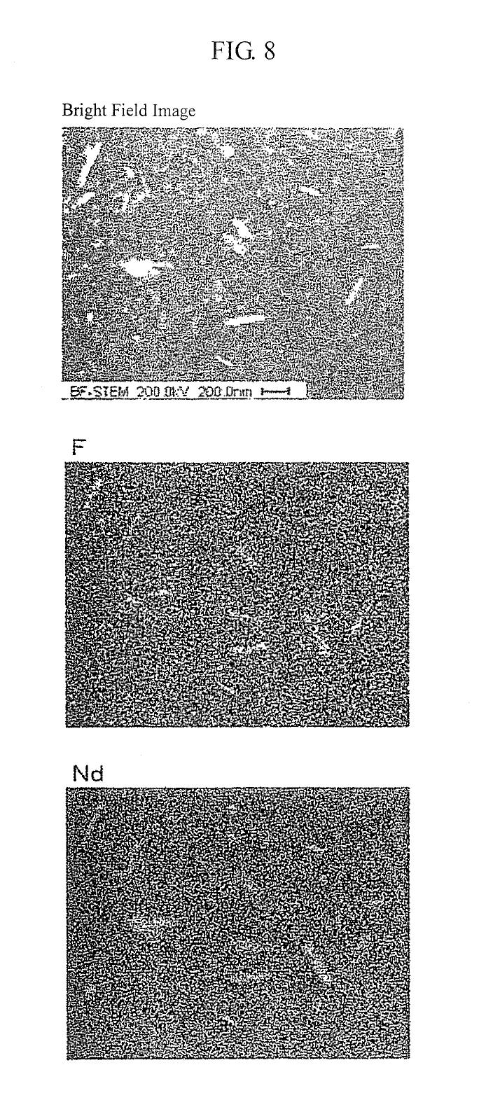

FIG. 8 shows a bright field image of a cross section of the magnetic powder after the thermal treatment in a transmission electron microscope observation. White plate-like or layer-like bodies were observed in the bright field image. The crystal grain size of the mother phase was 50 nm or smaller. The long axis of many of the plate-like bodies was longer than that of the mother phase crystal grain, and the short axis was equivalent to or shorter than that of the mother phase crystal grain. It was also observed that plate-like bodies grew while being in contact with the multiple crystal grains of the mother phase, and the directions of long axes were mostly random. Analysis images of F (fluorine) and Nd (neodymium) are presented below the bright field image in FIG. 8. The bright field image and the F and Nd analysis images were obtained at the same observation site. The plate-like bodies observed in white in the bright field image were, as suggested in the F and Nd analysis images below, the areas having high concentrations of F and Nd. Thus, it was suggested that the plate-like bodies contained a rare earth element and fluorine. Selected-area electron beam diffraction image observation indicated that the plate-like bodies had the basic structure of a rare earth fluorine compound. It was found that the plate-like bodies having NdF₂ and NdF₃ in the basic structure included oxygen in part; thus, it was possible that the plate-like bodies had become an oxygen-fluorine compound. When the treating solution alone was heated, the treating solution exhibited the structure of NdF₃. The concentration of fluorine in the plate-like bodies was lower than that of the fluorine compound prepared with the treating solution alone. This indicated that the magnetic powder and the fluorine compound in the periphery of the magnetic powder reacted with each other in the thermal treatment after the surface treatment, and then the fluorine atoms on the periphery migrated with the rare earth atoms. According to the above-described result, it was assumed that the concentration distributions of the rare earth element, oxygen, and fluorine in the plate-like bodies or in the diffusion path of the plate-like body contributed to the increase of the coercive force. To be more specific, according to the segregation of Dy and Nd to the vicinity of the diffusion path in which the plate-like bodies have been formed, and the segregation of Nd, Dy, and fluorine in the plate-like bodies, it was assumed that the increase of an anisotropic energy, the improvement of lattice matching in the grain boundary, and the reduction reaction of the mother phase by fluorine contributed to the improvement in magnetic characteristics. The fluorine compounds can provide any of effects as described above, such as an increase of coercive force; an improvement of squareness, an enhancement of resistivity after molding, a reduction in temperature dependence of coercive force and residual magnetic flux density, an enhancement of corrosion resistance, an increase of mechanical strength, an improvement of thermal conductivity, and an increase of magnetic adhesiveness. The fluorine compounds include, in addition to DyF₃, the following compounds and such fluorine compounds including oxygen or carbon: LiF, MgF₂, CaF₂, ScF₃, VF₂, VF₃, CrF₂, CrF₃, MnF₂, MnF₃, FeF₂, FeF₃, CoF₂, CoF₃, NiF₂, CuF₂, CuF₃, SnF₂, SnF₃, ZnF₂, A1F₃, GaF₃, SrF₂, YF₃, ZrF₃, NbF₅, AgF, InF₃, SnF₄, BaF₂, LaF₂, LaF₃, CeF₂, CeF₃, PrF₂, PrF₃, NdF₂, SmF₂, SmF₃, EuF₂, EuF₃, GdF₃, TbF₃, TbF₄, DyF₂, NdF₃, HoF₂, HoF₃, ErF₂, ErF₃, TmF₂, TmF₃, YbF₃, YbF₂, LuF₂, LuF₃, PbF₂, and BiF₃. These compounds are transparent to visible light, and can be formed in a surface treatment process using a solution whose X-ray diffraction peak had a half-value width of 1° or larger. In the surface treatment process, the formation of plate-like or layer-like fluorine compounds and oxygen-fluorine compounds was observed in the grain boundary and in the interior of the grain. Among these fluorine compounds, some of the fluorine compounds exhibited improved magnetic characteristics. The crystalline structures of the main phases after the thermal treatment for such fluorine compounds having improved magnetic characteristics are collectively shown in Table 1. In addition to the formation of NdF₂ and NdF₃ structures, an oxygen-fluorine compound composed of a rare earth oxygen-fluorine compound and the constituents of the treating solution used was observed.

### EXAMPLE 8

An optically transparent rare earth fluorine compound solution in a sol or gel form, whose X-ray diffraction pattern had a diffraction peak of 1° or larger was coated on the surface of a NdFeB-based sintered magnet. The diffraction pattern is mainly a pattern including broad peaks each having a half-value width of 1° or larger. A sharp pattern of the metal fluorine compound or metal oxygen-fluorine compound may be included in such a diffraction pattern having the broad peaks. A half-value width referred herein may be either an integral width of a diffraction peak or a width at half of peak intensity.

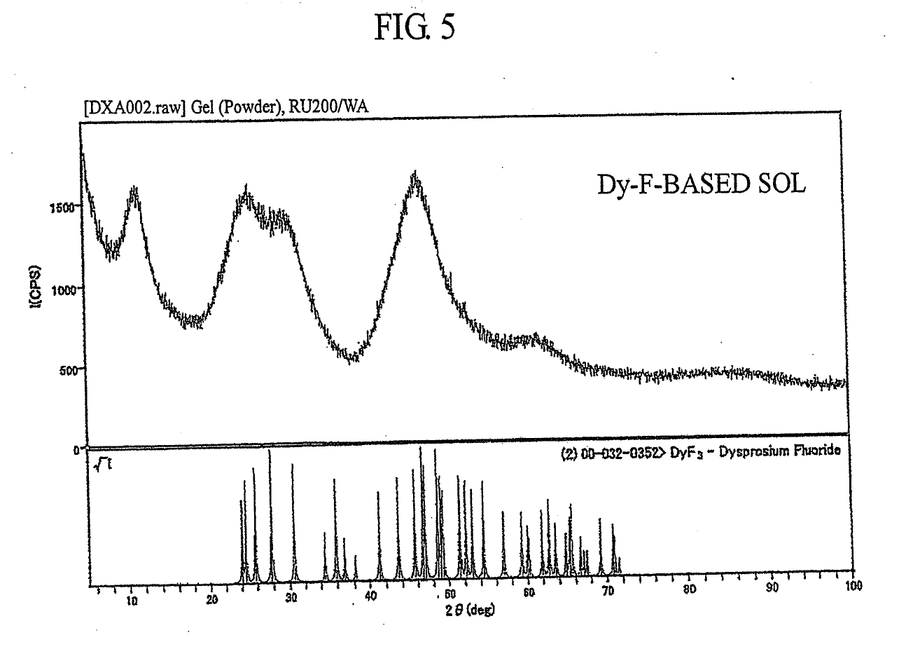

FIG. 5 shows an X-ray diffraction pattern of a Dy—F-based gel. The upper drawing in FIG. 5 shows an X-ray diffraction pattern of the Dy—F-based treating solution of the present invention, and the lower drawing shows an X-ray diffraction pattern of the DyF₃ powder. As observed in FIG. 5, the X-ray diffraction pattern of the treating solution of the present invention, unlike the pattern in which multiple sharp peaks overlap to form a broad peak, is similar to the pattern of amorphous, whose peak had a half-value width of 1° or larger. The pattern in the lowest angle region was derived from the supporting material. A broad peak was observed in a range corresponding to the range of plane distance from 1.0 angstrom to 4.5 angstroms. A peak is also observed in the range of 20 over 60° in the pattern. Hence, it was suggested that the treating solution of the present invention does not have a simple amorphous structure but a structure completely different from that of DyF₃. The thickness of the rare earth fluorine compound coated ranged from 1 nm to 10,000 nm. When the solvent was removed, a sharp diffraction pattern was observed within a broad diffraction pattern. Further heating increased the intensity of sharp diffraction peaks. The NdFeB-based sintered magnet, which has Nd₂Fe₁₄B as the main phase, exhibited the deterioration in magnetic characteristics on the surface of the sintered magnet due to the process-polishing. In order to avoid such deterioration in magnetic characteristics, the surface of the sintered magnet was coated with an optically transparent rare earth fluorine compound coated, dried, and then heated at temperature between 500° C. and the sintering temperature. Grains having a size ranging from 1 nm and 50 nm grew out of the rare earth fluorine compound solution in a gel or sol form immediately after coating and drying. Further heating caused reactions with the grain boundary or the surface of the sintered magnet, and also caused to diffuse. A fluorine compound was formed on almost entire surface of the sintered magnet. Therefore, before the heating process at 500° C. or higher after the coating and drying processes, a part of the region having a high rare earth element concentration on the surface of the crystalline particle which is a part of the surface of the sintered magnet, was fluorinated. With, especially among the above-mentioned rare earth fluorine compounds, the Dy fluorine compound, Tb fluorine compound, and Ho fluorine compound, deterioration in magnetic characteristics could be avoided, since the constituent elements of these compounds, such as Dy, Tb, and Ho, diffused along the grain boundary. The heat treatment at 800° C. or higher further facilitated the mutual diffusion between the fluorine compound and the sintered magnet. The higher the temperature of heat treatment, the more likely that the concentration of the constituent elements of the mother phase in the fluorine compound layer was increased. For stacking and bonding of a sintered magnet, a fluorine compound or oxygen-fluorine compound, which is the same with or different from the fluorine compound used to improve magnetic characteristics upon being diffused, was coated on the surface of the sintered magnet to form a bonding layer after the heat treatment. Then, the coated sintered magnet was stacked and irradiated with a millimeter wave thereon. In this process, it was possible to bond the sintered magnet by heating only the region near the bonding layer. A fluorine compound to form a bonding layer was any of Nd fluorine compounds, such as NdF₂₋₃ and Nd(OF)₁₋₃, and fluorine compounds in a gel form. It was possible to selectively heat the region near the bonding layer upon preventing temperature rise in the center of the sintered magnet by selecting irradiation conditions for the millimeter wave irradiation. Hence, it was possible to prevent deterioration in magnetic characteristics of a sintered magnet and changes in size thereof due to the bonding. Such effects of the millimeter wave was also observed in the following compounds in addition to the above-described compounds in a gel form: various metal fluorine compound powders, such as DyF₃, TbF₃, and NdF₃; metal oxygen-fluorine compound powders, such as DyOF and TbOF; metal nitrogen compound powders; metal carbon compound powders, and metal oxide compound powders. Combination of these powders and an Fe-based magnetic material allows utilization of local heating, and thereby allows surface modification, bonding, and sintering to be performed. For the combination of NdFeB and metal fluorine compounds, irradiation with a millimeter wave could shorten the treatment time required for selective heating to less than half of that required in the original heat treatment. Hence, such an application is suitable for mass production in which magnetic characteristics can be improved in a bonding process. A millimeter wave can be used not only for bonding sintered magnets but also for improvement in magnetic characteristics by diffusion of a coating material. The function of bonding layer can be achieved by using any of the following materials, in addition to the fluorine compounds, having dielectric loss which is different from that of the NdFeB mother phase: oxides; nitrogen compounds; carbides; fluorine compounds in a gel form; oxides in a gel form; carbides in a gel form; hydrates; and solutions and slurries including these compounds. Although it is still possible to diffuse only by heating without the use of a millimeter wave, the utilization of a millimeter wave as described above allows the fluorine compound to be heated selectively within a certain temperature range, and thereby can be adopted for the bonding and attachment of magnetic materials, various metal materials, and oxide materials. This is because fluorine compound-based materials can be more easily heated in a certain temperature range by irradiation with an electromagnetic wave, such as a millimeter wave, than Fe-based materials, such as NdFeB, as the mother phase. The millimeter wave irradiation can be conducted, for example, in the following conditions: 28 GHz; 1 kW to 10 kW; under an Ar atmosphere, in vacuum, or under other inert gas atmospheres; and irradiation period of 1 minute to 30 minutes. Since the fluorine compound or oxygen-fluorine compound containing oxygen is selectively heated by irradiating with a millimeter wave, it is possible to diffuse constituents of the fluorine compound mainly along the grain boundary without changing much of the organization of the sintered body. Hence, it is possible to prevent the constituents of the fluorine compound from diffusing into the interior of the crystal grain. As a result, higher magnetic characteristics, such as a high residual magnetic flux density, improved squareness, high coercive force, high Curie temperature, low thermal demagnetization, high corrosion resistance, and high resistivity, is obtained by the irradiation of a millimeter wave than by heating using a simple external heat source. According to selections of millimeter wave irradiation conditions and fluorine compound, it is possible to diffuse the constituent elements of the fluorine compound into a deeper part from the surface of a sintered magnet than that in a case of a regular thermal treatment, and even into the center of a magnet having a size of 10 cm×10 cm×10 cm. A sintered magnet obtained in such a process has a residual magnetic flux density ranging from 1.0 T to 1.6 T, and a coercive force ranging from 20 kOe to 50 kOe; thus, the heavy rare earth element concentration in the sintered rare earth magnet having equivalent magnetic characteristics can be lowered in comparison with that in the case of using a conventional NdFeB-based magnetic powder added with a heavy rare earth element. Furthermore, when the fluorine compound or oxygen-fluorine compound containing at least one of alkaline elements, alkaline earth elements, and rare earth elements having a size ranging from 1 nm to 100 nm remains on the surface of the sintered magnet, the sintered magnet surface acquires a high resistivity; thus, it is possible with such a sintered magnet to reduce an eddy current loss upon stacking and bonding, and to reduce a loss in a high-frequency magnetic field. Such reductions in loss can reduce heat generation of the magnet, and thereby can reduce the use of heavy rare earth element. Since the above-described rare earth fluorine compounds are not in a powder form but have a low viscosity, and can be coated inside of micropores having a size ranging from 1 nm to 100 nm, these rare earth fluorine compounds can be used for improvement in magnetic characteristics of small magnet parts.

### EXAMPLE 9

An Fe-fluorine compound in a gel or sol form including Fe ions or Fe clusters mixed therein was prepared by adding at least one atomic percent of Fe to a fluorine compound solution having a peak having a half-value width ranging from 1° to 10° as a main peak in an X-ray diffraction pattern. In this process, some of the Fe atoms were chemically bound to the fluorine in the fluorine compound, or to at least one of the constituent elements of the fluorine compound, which include alkaline elements, alkaline earth elements, Cr, Mn, V, and rare earth elements. The number of atoms contributing to the chemical bond among the fluorine atom, Fe atom, and at least one of the constituent elements of the fluorine compound was increased by irradiating the fluorine compound or fluorine compound precursor, which was in a gel or sol form, with an electromagnetic wave, such as a millimeter wave and microwave. A fluorine compound of a multi-component system of at least three elements composed of Fe, fluorine, and at least one of the fluorine compound constituent elements was formed. It was possible to synthesize a fluorine compound having a coercive force of 10 kOe or higher with irradiation of a millimeter wave. Any other transition metal element ion may be added as a part of or as an alternative for Fe ions. In this method, it was possible to obtain a magnet material without dissolution and grinding processes required in a conventional method for obtaining a magnetic powder; thus, the method can be adopted in production of various magnetic circuits. It was possible also to obtain Fe-M-F-based, Co-M-F-based, and Ni-M-F-based magnets, where M represents a constituent element of the fluoride component, including alkaline elements, alkaline earth elements, Cr, Mn, V, and rare earth elements, having a high coercive force using the fluorine compound in a gel, sol, or solution form. Since the preparation involves providing the coating of the solution and millimeter wave irradiation on any substrate that is resistant to dissolution by millimeter wave irradiation, the fluorine compound magnet can be used for production of a magnetic part having a shape difficult to be machined. Incidentally, contamination of other atoms, such as oxygen, carbon, nitrogen, and boron, in the fluorine compound magnet did not make any difference in terms of magnetic characteristics. It was also possible to obtain a material exhibiting fluorescent characteristics in such a material system.

### EXAMPLE 10

A fluorine compound solution having an X-ray diffraction pattern including a broad diffraction peak was provided on the surface of a SmFeN-based magnetic powder having a grain size ranging from 0.1 μm to 100 μm. The fluorine compound included at least one of alkaline elements, alkaline earth elements, and rare earth elements. The SmFeN-based magnetic powder coated with the solution was mounted into a metal mold, subjected to a compression molding process while being aligned to the direction of a magnetic field of 3 kOe to 20 kOe to prepare a preliminary compact. The anisotropic preliminary compact was heated by irradiation with a millimeter wave, and thereby the fluorine compound was selectively heated. While preventing deterioration of magnetic characteristics due to structural change and the like of the SmFeN-based magnetic powder during heating, and having the fluorine compound serving as a binder, it was possible to prepare an anisotropic magnet, and thereby obtain a magnet to which the SmFeN magnetic powder particles are bound by the fluorine compound. By setting the percentage of the volume of the fluorine compound in the magnet between 0.1% and 3%, it was possible to obtain an anisotropic SmFeN magnet having a residual magnet flux density of 1.0 T or higher. It was also possible to improve the magnetic characteristics by impregnating the preliminary compact into the fluorine compound solution and then heating the impregnated preliminary compact. The interaction of formed locally Sm—Fe—N—F or Sm—Fe—N—O with the fluorine compound caused any of the following effects: an increase of coercive force; improvement of squareness; and increase of residual magnetic flux density. In the case of a nitrogen-based magnetic powder, such as a SmFeN-based magnetic powder, a SmFeN-based magnetic powder was prepared by irradiation of a SmFe powder with a millimeter wave, and had the coercive force more significantly increased due to nitriding than that in a conventional ammonium nitriding treatment, resulting in obtaining a coercive force of 20 kOe or higher. The technique for binding by a fluorine compound with millimeter wave irradiation can be used for other iron-based materials, such as Fe—Si-based, Fe—C-based, Fe—Ni-based, Fe—Co-based, Fe—Si—B-based, and Co-based magnetic materials. The technique can also be used for a soft magnetic powder, a soft magnetic ribbon, a soft magnetic compact, a hard magnetic powder, a hard magnetic ribbon, and a hard magnetic compact without deteriorating the magnetic characteristics thereof. The technique can also be used for binding other metal materials.

### EXAMPLE 11

An Fe-fluorine compound in a gel or sol form having Fe-based particulates mixed therein was prepared by adding particulates including 1 atomic percent Fe or higher having a grain size ranging from 1 nm to 100 nm to a fluorine compound solution having a broad peak in an X-ray diffraction pattern. The above-mentioned broad peak refers to a main peak having a half-value width of 1° or larger in a diffraction pattern measured in a 0-20 scan using a Cu—Kα ray. Some of the Fe atoms located on the surface of the particulate were chemically bound to the fluorine in the fluorine compound, or to at least one of the constituent elements of the fluorine compound, including alkaline elements, alkaline earth elements, and rare earth elements. The number of atoms contributing to the chemical bond among the fluorine atom, Fe atom, and at least one of the constituent elements of the fluorine compound was increased by irradiating the fluorine compound or fluorine compound precursor in a gel or sol form including the particulates with a millimeter wave or microwave. A fluorine compound of a multi-component system of at least three composed of Fe, fluorine, and at least one of the constituent elements of the fluorine compound was formed. It was possible to synthesize a fluorine compound having a coercive force of 10 kOe or higher with millimeter wave irradiation or microwave irradiation. Other transition metal element particulates may be added as an alternative for the Fe-based particulates. In this method, it was possible to obtain a magnet material without dissolution and grinding processes which are required in a conventional method for obtaining a magnetic powder; thus, the method can be used for production of various magnetic circuits. It was possible to obtain Fe-M-F-based, Co-M-F-based, and Ni-M-F-based magnets, where M represents the constituent elements of the fluorine compound including an alkaline element, an alkaline earth element, or a rare earth element, having a high coercive force by the method for adding particulates to a fluorine compound in gel, sol, or solution form. Since the preparation involves providing the coating of the solution on various substrates and millimeter wave irradiation, the fluorine compound magnet can be used for production of a magnetic part having a shape difficult to be machined. Incidentally, contamination of atoms, such as oxygen, carbon, and nitrogen, in the fluorine compound magnet did not make any difference in terms of magnetic characteristics. The optically transparent fluorine compound was inserted into a shape patterned by a resist and the like, dried, and heated at temperature below the upper temperature limit of the resist. Further heating after the removal of the resist provided an increased coercive force. The fluorine compound in a sol or gel form can be injected or coated in a space of a resist spacing of 10 nm or larger and of a thickness of the magnet part of 1 nm or larger; thus, it is possible to prepare a small magnet having a three-dimensional shape without using any machine processing and physical processes, such as evaporation coating and sputtering. The Fe-M-F-based magnet can be caused to absorb only light having a certain wavelength by adjusting the concentration of F. Hence, the fluorine compound in this example can be adopted as a part such as an optical part, and an optical recording device, or a surface treatment material thereof.

### EXAMPLE 12

An optically transparent fluorine compound whose X-ray diffraction peak had a half-value width of 1° or larger was added with particles having a grain size ranging from 10 nm to 10,000 nm containing at least one of rare earth elements. For example, a particle having a Nd₂Fe₁₄B structure in the main phase was used. The fluorine compound was coated on the surface of the particle. Having a mixing ratio of the fluorine compound solution and the particles, or coating conditions as a parameter, it was possible to change a percentage of surface coverage of the particle. An increased coercive force by the fluorine compound was observed when the percentage of coverage was in a range from 1% to 10%. An improved squareness or an improved Hk in a demagnetization curve in addition to the increased coercive force was observed when the percentage of coverage was in a range from 10% to 50%, and an enhanced resistivity after the formation was observed when the percentage of coverage was in a range from 50% to 100%. Percentage of coverage herein refers to a percentage of a surface area on which a coated material is provided in the whole surface area of a particle. Particles having a percentage of coverage in a range from 1% to 10% were placed in a magnetic field for preliminary molding, and then heated at temperature of 800° C. or higher to form a sintered magnet. The fluorine compound for coating includes at least one of rare earth elements. Utilization of a fluorine compound in a solution form allowed the fluorine compound to be coated along a particle interface in the form of laminae or plate, and allowed the fluorine compound to be coated in the form of laminae even on a nonuniform particle surface. In particles having a percentage of coverage in a range from 1% to 10%, the rare earth element included in the fluorine compound in the form of laminae diffused along the grain boundary in the thermal treatment after the preliminary molding in a magnetic field, and therefore the coercive force was increased compared to the case of particles having no coating. Incidentally, when a fluorine compound was provided to an Fe-based particle, a part having no coating material thereon of the particle surface was fluorinated. Hence, in a particle having a percentage of coverage in a range from 1% to 10%, even if the area in which the fluorine compound is formed is in a range from 1% to 10%, 90% of the particle surface is, although depending on the particle composition and the surface condition, fluorinated, and the surface resistivity of the particle is enhanced as the magnetic characteristics of the surface boundary changed. Since rare earth elements are prone to be fluorinated, a particle having a higher rare earth element concentration on the surface gains higher resistivity on the particle surface due to the fluorination of a part of the particle surface upon being coated with a fluorine compound in a gel or sol form on the particle surface. When such a particle having high resistivity is sintered, the rare earth element in the interior of the particle is bound to fluorine on the particle surface thereby to form a structure having the rare earth element segregated near the grain boundary, resulting in an increased coercive force. In other words, fluorine demonstrates an effect of trapping a rare earth atom, and inhibits diffusion of the rare earth elements into the interior of the particle, causing the rare earth elements segregated in the grain boundary. Therefore, it is possible to increase the coercive force, to reduce the concentration of rare earth elements in the interior of a particle, and to obtain a high residual magnetic flux density.

### EXAMPLE 13

A fluorine compound solution transparent to visible light, whose X-ray diffraction peak had a half-value width of 1° or larger was added with particles having a grain size ranging from 10 nm to 10,000 nm containing at least one of rare earth elements. For example, a particle or a small magnet having a Nd₂Fe₁₄B structure in the main phase was used. After the fluorine compound came into contact with the surface of the particle, the fluorine compound coating solution attached on the surface of the particle was removed by use of a solvent and the like. The aggregated fluorine compound on the particle surface was removed as much as possible to achieve an average percentage of coverage of the residual coating material of 10% or below. Hence, an average of 90% or above of the particle surface had no coating material is formed thereon (no clear fluorine compound coating was observed in an electron scanning microscopic image at 10,000 magnification). In a part of this surface, some of the rare earth elements constituting the particle were fluorinated, and thereby provided a layer containing a high level of fluorine. A part of the particle surface was fluorinated because a rare earth element is prone to be bound to a fluorine atom. If there is no rare earth element, the fluorination is not likely to occur on the surface. When some of the rare earth elements were fluorinated, a phase made of rare earth elements bound to fluorine was formed on the particle surface. In this case, an oxygen-fluorine compound may be formed because the rare earth elements are also prone to be bound to an oxygen atom. The fluorinated particles were subjected to a compression molding process in a magnetic field, and then sintered to prepare an anisotropic sintered magnet. It was also possible that the preliminary compact having a density ranging from 50% to 90% obtained in the compression molding process in a magnetic field was impregnated in the fluorine compound solution to provide a coating, with a fluorine compound precursor, partially on the particle surface and the particle surface having cracks thereon. This impregnation process allowed the fluorine compound, including the part having cracks thereon, having a size ranging from 1 nm to 100 nm, to be coated with the fluorine compound precursor, and thereby contributed to any of the effects including: an increase of coercive force; an improvement of squareness; an enhancement of resistivity; an increase of residual magnetic flux density; a reduction of the use of rare earth element; an improvement of strength; and a provision of anisotropy to a magnetic powder. The sintering process involved diffusion of the fluorine and rare earth element. Compared to the case without fluorination, an increase of a coercive force by fluorination became significant as the amount of heavy rare earth element added increased. The concentration of heavy rare earth element required to obtain a sintered magnet having an equivalent coercive force can be reduced by fluorination. This is assumed to be because a high coercive force is achieved by a structure having a heavy rare earth element segregated in the vicinity of the grain boundary because the heavy rare earth element is likely to be segregated in the vicinity of the fluorinated phase due to fluorination. Such a heavy rare earth element segregates in the region having a width of approximately 1 nm to 100 nm from the grain boundary.

### EXAMPLE 14

An oxide particle having a grain size ranging from 1 nm to 10,000 nm including at least one of rare earth elements was coated with a fluorine compound solution transparent to visible light whose X-ray diffraction peak had a half-value width of 1° or larger, and then heated at temperature ranging from 800° C. to 1200° C. or heated by irradiation with electromagnetic wave, such as a millimeter wave. In the heating process, an oxygen-fluorine compound was formed in a part. The adoption of the fluorine compound solution including at least one of rare earth elements caused the formation of the oxygen-fluorine compound or fluorine compound, resulting in improvement in magnetic characteristics of an oxide, which was a barium ferrite or strontium ferrite particle; thus, an increased coercive force, improved squareness of a demagnetization curve, and improved residual magnetic flux density were observed. In particular, the residual magnetic flux density was largely increased by using a fluorine compound solution including at least 1% of iron. The oxide particle of the oxygen-fluorine compound may be prepared in a sol-gel process.

### EXAMPLE 15

A Co-fluorine or Ni-fluorine compound solution in a gel or sol form including Co or Ni ions, or Co or Ni clusters mixed therein was prepared by adding at least 1 atomic percent of Co or Ni to an optically transparent fluorine compound solution whose X-ray diffraction peak had a half-value width of 1° or larger. In this process, some of the Co or Ni atoms were chemically bound to the fluorine in the fluorine compound, or to at least one of the constituent elements of the fluorine compound, including alkaline elements, alkaline earth elements, and rare earth elements. The number of atoms contributing to the chemical bond among the fluorine atom, Co atom or Ni atom, and at least one of the constituent elements of the fluorine compound was increased by irradiating the optically transparent fluorine compound or fluorine compound precursor with a millimeter wave or a microwave and then by drying. A fluorine compound of a multi-component system of at least three composed of Co or Ni, fluorine, and at least one of the fluorine compound constituent elements was formed. It was possible to synthesize a fluorine compound having a coercive force of 10 kOe or higher with irradiation of a millimeter wave. Other transition metal element ions may be added as a part of or as an alternative for the Co or Ni ion. In this process, it was possible to obtain a magnet material without dissolution and grinding processes required in a conventional method for obtaining a magnetic powder; thus, this process can be adopted in production of various magnetic circuits. It was possible to obtain a Co-M-F-based or Ni-M-F-based magnet, where M represents the constituent elements of the fluorine compound, including alkaline elements, alkaline earth elements, and rare earth elements, having a high coercive force in the form of magnet or magnetic powder using the optically transparent fluorine compound in a solution form. Since the preparation involves providing the coating of the solution and millimeter wave irradiation on various substrates that are resistant to dissolution by millimeter wave irradiation, the fluorine compound magnet can be used for production of a magnetic part having a shape difficult to be machined. Incidentally, contamination of other atoms, such as oxygen, carbon, and nitrogen, in the fluorine compound magnet did not make any difference in terms of magnetic characteristics.

### EXAMPLE 16

An Fe-fluorine compound including Fe-based particulates mixed therein was prepared by adding a particulate including at least 1 atomic percent of Fe having a grain size ranging from 1 nm to 100 nm to a fluorine compound solution, which was transparent to visible light, and whose multiple diffraction peaks each had a half-value width of 1° or larger in an X-ray diffraction pattern. In this process, some of the Fe atoms on the surface of the particulate were chemically bound to the fluorine in the fluorine compound, or to at least one of the constituent elements of the fluorine compound, including alkaline elements, alkaline earth elements, and rare earth elements. The number of atoms contributing to the chemical bond among the fluorine atom, Fe atom, and at least one of the constituent elements of the fluorine compound was increased by irradiating the optically transparent fluorine compound or fluorine compound precursor, which had low viscosity, and which included the particulate or cluster, with a millimeter wave or microwave. Therefore, the magnetization between Fe atoms partly became ferromagnetic due to any of the following bonds: a bond between the Fe atom and rare earth element through the fluorine atom; bonds between the fluorine atom and oxygen atom, and between the Fe atom and rare earth element; and a bond of the rare earth element with the fluorine atom, oxygen atom, and Fe atom. The magnetization of some of the Fe atoms involved an antiferromagnetic bond. A structure favorable to a ferromagnetic bond was formed by irradiation with a millimeter wave or a microwave; thus, it was possible to synthesize a fluorine compound containing Fe having a coercive force of 10 kOe or higher. Other transition metal element particulates may be added as an alternative for the Fe-based particulate. In other words, it is possible to obtain a permanent magnet material from other transition metal elements, such as Cr, Mn, and V, in addition to Co and Ni, in this method involving no dissolution and grinding processes that are required in a conventional method for obtaining a magnetic powder; thus, the method can be adopted in production of various magnetic circuits.

### EXAMPLE 17

An Fe-fluorine compound including Fe-based particulates mixed therein was prepared by adding a particulate including at least 1 atomic percent of Fe having a grain size ranging from 1 nm to 100 nm to an optically transparent fluorine compound solution whose X-ray diffraction peak had a half-value width of 1° or larger. In this process, some of the Fe atoms on the surface of the particulate were chemically bound to the fluorine in the fluorine compound, or to at least one of the constituent elements of the fluorine compound, including alkaline elements, alkaline earth elements, and rare earth elements. The number of atoms contributing to the chemical bond among the fluorine atom, Fe atom, and at least one of the constituent elements of the fluorine compound was increased by irradiating the fluorine compound or fluorine compound precursor, which had low viscosity, and which included the particulate or cluster, with a millimeter wave and microwave. Therefore, the magnetization between Fe atoms partially became ferromagnetic due to any of the following bonds: a bond between the Fe atom and rare earth element through the fluorine atom; bonds between the fluorine atom and oxygen atom, and between the Fe and rare earth element; and a bond of the rare earth element with the fluorine atom, oxygen atom, and Fe atom; thus, the magnetization between Fe atoms becomes anisotropic. In the particulate, a phase including a high level of fluorine (fluorine concentration ranging from 10% to 50%), a phase including a high level of Fe (Fe concentration ranging from 50% to 85%), and a phase including a high level of rare earth element (rare earth element concentration ranging from 20% to 75%) were formed. The Fe-rich phase contributed to the magnetization, while the fluorine-rich or rare earth element-rich phase contributed to a high coercive force. The magnetization of some of the Fe atoms involved an antiferromagnetic bond. A structure favorable to a ferromagnetic bond was formed by irradiation with a millimeter wave or a microwave; thus, it was possible to synthesize a fluorine compound having a coercive force of 10 kOe or higher. Other transition metal element particulates may be added as an alternative for the Fe-based particulate. It is possible to obtain a permanent magnet material in this method involving no dissolution and grinding processes that are required in a conventional method for obtaining a magnetic powder; thus, the method can be adopted in production of various magnetic circuits.

### EXAMPLE 18

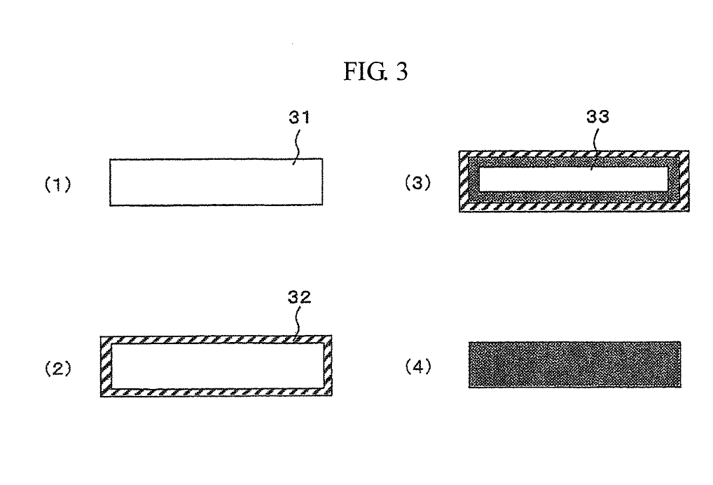

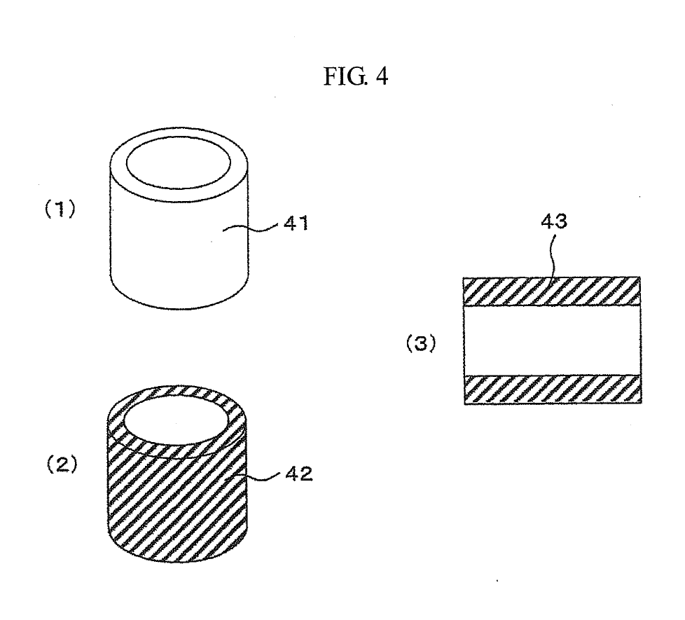

A NdFeB-based sintered magnet having Nd₂Fe₁₄B in the main phase was provided, on the surface, with the coating of an optically transparent rare earth fluorine compound whose X-ray diffraction peak had a half-value width ranging from 1° to 10°. The average film thickness of the rare earth fluorine compound after the coating ranged from 1 nm to 10,000 nm. The NdFeB-based sintered magnet, which had an average crystalline grain size ranging from 1 μm to 20 μm, and had Nd₂Fe₁₄B in the main phase, is shown as a sintered magnet 31 in FIG. 3. Deterioration of magnetic characteristics on the surface of the sintered magnet 31 due to the processing or polishing was observed in a demagnetization curve. In order to prevent such deterioration of magnetic characteristics, and segregate the rare earth element in the vicinity of the grain boundary to increase a coercive force, to improve squareness of a demagnetization curve, to enhance resistivity on the magnet surface or near the grain boundary, to raise Curie temperature by the fluorine compound, to improve strength, to enhance the corrosion resistance, to reduce the use of rare earth element, and to reduce a magnetic field for magnetization, the sintered magnet was coated with a rare earth fluorine compound solution 32 on the surface, dried, and then heated at temperature ranging from 300° C. to the sintering temperature. A cluster having grown out of the rare earth fluorine compound solution grew to be a particle having a size ranging between 1 nm and 100 nm inclusive immediately after the coating and drying. Further heating caused reactions with the grain boundary or the surface of the sintered magnet, and also caused to diffuse thereby to form a diffusion layer 33. Selecting thermal treatment conditions caused the diffusion layer to cover the entire magnet; thus, magnetic characteristics could be improved. Since the fluorine compound cluster after the coating and drying did not go through a grinding process, having no protrusion or sharpness on the surface, the cluster particle exhibited a rounded shape, such as an oval-shape or a circle shape, with no crack in transmission electron microscopic observation. At the same time as being fused together and growing on the surface of the sintered magnet by heat, these particles diffused along the grain boundary of the sintered magnet or diffused mutually with the constituent element of the sintered magnet. Furthermore, since the clustered rare earth fluorine compound was coated on the surface of the sintered magnet, the fluorine compound was formed on almost the entire surface of the sintered magnet. Therefore, before the heating process at temperature ranging from 300° C. to the sintering temperature after the coating and drying, a part of a region having a high rare earth element concentration on the surface of the crystalline particle on a part of the surface of the sintered magnet was fluorinated. The fluorinated phase and the fluorinated phase containing oxygen grew upon partly maintaining consistency with the mother phase. A fluorine compound phase or an oxygen-fluorine compound phase grew consistently outside of the mother phase of the fluorinated phase or the oxygen-fluorinated compound. Segregation of a heavy rare earth element or transition metal element in the fluorinated phase, the fluorine compound phase, the oxygen-fluorine compound phase, or the carbonized oxygen-fluorine compound phase increased the coercive force. It is preferable that the width of a band region where a heavy rare earth element is concentrated along the grain boundary range from 1 nm to 100 nm. In this range of the band region, a high residual magnetic flux density and a high coercive force are achieved. The region where the heavy rare earth element segregated was often larger than the region where the fluorine segregated. The segregation of heavy rare earth element increased the magnetic anisotropic energy, and thereby increased the coercive force. At the same time, the presence of fluorine in the grain boundary reduced the roughness of the grain boundary, narrowed the width of the grain boundary, and removed oxygen in the grain, thus resulting in improved squareness in magnetic characteristics. When Dy was concentrated along the grain boundary in this process, the sintered magnet obtained had a residual magnetic flux density ranging from 1.0 T to 1.7 T and a coercive force ranging from 20 kOe to 50 kOe. The heavy rare earth element concentration provided in a sintered rare earth magnet having equivalent magnetic characteristics was allowed to be lower than that in the case of sintering a conventional NdFeB-based magnetic powder added with a heavy rare earth element. The Fe concentration in the fluorine compound on the surface of the sintered magnet varied according to thermal treatment temperature. The Fe in a concentration range from 10 ppm to 5% inclusive diffused into the fluorine compound by heating at temperature of 1000° C. or higher. Although the Fe concentration reached 50% near the grain boundary of the fluorine compound, magnetic characteristics of the overall sintered magnet were not affected as long as the average concentration stayed between 1% and 5% inclusive. The fluorine compound solution can be coated not only on the sintered magnetic block shown in FIG. 3 but also on a ring magnet shown in FIG. 4. The solution was coated on the surface of a ring magnet 41 to form a surface diffusion layer 42 and an internal diffusion layer 43 shown in a cross section (3). Various effects, such as improved magnetic characteristics (improved squareness, and increased coercive force), improved temperature characteristics (reduced temperature dependence of magnetic characteristics), increased electric resistance, improved mechanical strength, and enhanced corrosion resistance and reliability, can be expected.

### EXAMPLE 19

An Fe-fluorine or Co-fluorine compound in a gel or sol form including Fe-based or Co-based particulates mixed therein was prepared by adding a particulate including at least 1 atomic percent of Fe or Co having a grain size ranging from 1 nm to 100 nm to a fluorine compound solution in a gel or sol form whose X-ray diffraction peak had a half-value width of 1° or larger. In this process, some of the Fe or Co atoms on the surface of the particulate were chemically bound to the fluorine in the fluorine compound, or to at least one of the constituent elements of the fluorine compound, including alkaline elements, alkaline earth elements, and rare earth elements. The number of atoms contributing to the chemical bond among the fluorine atom, nitrogen atom, Fe atom or Co atom, and at least one of the constituent elements of the fluorine compound was increased by irradiating the fluorine compound or fluorine compound precursor in a gel or sol form, which included the particulate or cluster, with a millimeter wave and microwave under an atmosphere containing nitrogen. Therefore, the magnetization between Fe atoms or between Co atoms partly became ferromagnetic due to any of the following bonds: a bond between the Fe atom or Co atom and rare earth element through the fluorine atom and nitrogen atom; bonds between the fluorine atom and oxygen atom, and between the Fe atom or Co atom and rare earth element; and a bond of the rare earth element with the fluorine atom, oxygen atom, nitrogen atom, and Fe atom or Co atom; thus, the magnetization between Fe or Co atoms becomes anisotropic. In the particulate, a phase including a high level of fluorine (fluorine concentration ranging from 10% to 50%), a phase including a high level of nitrogen (nitrogen concentration ranging from 3% to 20%), a phase including a high level of Fe or Co (Fe or Co concentration ranging from 50% to 85%), and a phase including a high level of rare earth element (rare earth element concentration ranging from 10% to 75%) were formed. The Fe-rich or Co-rich phase contributed to the magnetization, while the fluorine-rich and nitrogen-rich phases or the rare earth element-rich phase contributed to a high coercive force. Hence, a magnet having an Fe-M-F—N or Co-M-F—N quaternary system (M represents a rare earth element, an alkaline element, or an alkaline earth element), or Fe—Co-M-F, having a coercive force of 10 kOe or higher can be obtained.

### EXAMPLE 20

An Fe-fluorine compound cluster including Fe—B particulates mixed therein was prepared by adding a particulate including at least 1 atomic percent of Fe having a grain size ranging from 1 nm to 100 nm to a fluorine compound solution transparent to visible light whose X-ray diffraction peak had a half-value width of 1° or larger. The property of a soft magnetic component originating from Fe remained in the interior of a particulate having a grain size exceeding 100 nm after the subsequent process. On the other hand, it was difficult to improve magnetic characteristics of a particulate having a grain size below 1 nm due to a high oxygen concentration relative to Fe. Thus, it is preferable that the particulate have a particle size ranging from 1 nm to 100 nm. In this process, some of the Fe atoms on the surface of the Fe—B particulate were chemically bound to the fluorine in the fluorine compound, or to at least one of the constituent elements of the fluorine compound, including alkaline elements, alkaline earth elements, and rare earth elements. The number of atoms contributing to the chemical bond among the fluorine atom, boron (B) atom, Fe atom, and at least one of the constituent elements of the fluorine compound was increased by irradiating the fluorine compound or fluorine compound precursor, which included the particulate or cluster and the Fe—B in a gel or sol form, with an electromagnetic wave, such as a millimeter wave and microwave. Therefore, the magnetization between Fe atoms partly became ferromagnetic due to any of the following bonds: a bond between the Fe atom and rare earth element through the fluorine atom; bonds between the fluorine atom and boron atom, and between the Fe atom and rare earth element; and a bond of the rare earth element with the fluorine atom, oxygen atom, boron atom, and Fe atom; thus, the magnetization between Fe atoms becomes anisotropic. In the particulate, a phase including a high level of fluorine (fluorine concentration ranging from 10% to 50%), a phase including a high level of B (B concentration ranging from 5% to 20%), a phase including a high level of Fe (Fe concentration ranging from 50% to 85%), and a phase including a high level of rare earth element (rare earth element concentration ranging from 10% to 75%) were formed. The Fe-rich phase contributed to the magnetization, while the fluorine-rich, boron-rich phase, or rare earth element-rich phase contributed to a high coercive force. Hence, a magnet having an Fe-M-B—F quaternary system (M represents a rare earth element, an alkaline element, or an alkaline earth element) and having a coercive force of 10 kOe or higher can be obtained. It is possible to raise a Curie temperature to a range between 400° C. and 600° C. by replacing M with a heavy rare earth element.

### EXAMPLE 21

A NdFeB-based sintered magnet having a Nd₂Fe₁₄B structure in the main phase was provided, on the surface, with the coating of a fluorine compound cluster solution, capable of growing to be a rare earth fluorine compound at temperature of 100° C. or higher, and whose X-ray diffraction peak had a half-value width of 1° or larger. The average film thickness of the rare earth fluorine compound cluster after the coating ranged from 1 nm to 10,000 nm. This cluster, which did not show a crystalline structure of fluorine compound in a bulk, had a certain periodic structure of the fluorine and rare earth element being bound to each other, and a part of the structure had a longer period than that in a periodic structure of an amorphous material. The NdFeB-based sintered magnet had an average crystalline grain size ranging from 1 μm to 20 μm, and had a Nd₂Fe₁₄B structure in the main phase. Deterioration of magnetic characteristics on the surface of the sintered magnet due to the processing or polishing was observed in a demagnetization curve. In order to prevent such deterioration of magnetic characteristics, and segregate the rare earth element in the vicinity of the grain boundary to increase a coercive force, to improve squareness of a demagnetization curve, to enhance resistivity on the magnet surface or near the grain boundary, to raise Curie temperature by the fluorine compound, to improve strength, to enhance the corrosion resistance, to reduce the use of rare earth element, to reduce the magnetic field for magnetization, and to recover magnetic characteristics of a layer deteriorated by processing, the sintered magnet was coated with a rare earth fluorine compound precursor in a gel or sol form on the surface, dried, and then heated at temperature ranging from 300° C. to the sintering temperature. The rare earth fluorine compound cluster grew to be a particulate cluster having a size ranging between 1 nm and 100 nm inclusive during the coating and drying processes. Further heating caused reactions and diffusion between the precursor or some of the fluorine compound clusters and the grain boundary and/or the surface of the sintered magnet. The fluorine compound particle after the coating, drying, and heating did not go through a grinding process in a temperature range in which the particles were not fused together. Hence, having no protrusion or sharpness on the surface, the particle exhibited a rounded shape, such as an oval-shape or a circle shape, no crack in the interior of the particle or the particle surface, and no discontinuous nonuniformity in the outline in transmission electron microscopic observation. At the same time as being fused together and growing on the surface of the sintered magnet by heat, these particles diffused along the grain boundary of the sintered magnet or diffused mutually with the constituent element of the sintered magnet. Furthermore, since the clustered rare earth fluorine compound was coated on the surface of the sintered magnet, almost the entire surface of the sintered magnet was covered with the fluorine compound. Therefore, a part of a region having a high rare earth element concentration on the surface of the crystalline particle on a part of the surface of the sintered magnet after the coating and drying, was fluorinated. The fluorinated phase and the fluorinated phase containing oxygen, namely oxygen-fluorinated phase, grow upon partly maintaining consistency with the mother phase. A fluorine compound phase or an oxygen-fluorine compound phase grew consistently outside of the mother phase of the fluorinated phase or the oxygen-fluorinated compound. Segregation of a heavy rare earth element in the vicinity of the fluorinated phase, the fluorine compound phase, or the oxygen-fluorine compound phase increased the coercive force. It is preferable that the width of a band region where the heavy rare earth element is concentrated along the grain boundary range from 0.1 nm to 1,000 nm. In this range of the band region, a high residual magnetic flux density and a high coercive force were achieved. When Dy was concentrated along the grain boundary in this process using a DyF₂₋₃ precursor, the sintered magnet obtained had a residual magnetic flux density ranging from 1.0 T to 1.6 T and a coercive force ranging from 20 kOe to 50 kOe. The heavy rare earth element concentration provided in a sintered rare earth magnet having equivalent magnetic characteristics was allowed be lower than that in the case of sintering a conventional NdFeB-based magnetic powder added with a heavy rare earth element, or the case of sintering a magnet mixed with a powder having a high heavy rare earth element concentration, as in a binary alloying method. The Fe concentration in the fluorine compound on the surface of the sintered magnet varied according to thermal treatment temperature. The Fe in a concentration range from 1 ppm to 5% inclusive diffused into the fluorine compound by heating at temperature of 1000° C. or higher. Although the Fe concentration reached as high as 50% near the grain boundary of the fluorine compound, magnetic characteristics of the overall sintered magnet were not affected much as long as the average concentration was 5% or lower. The solution can be coated on an Fe-based soft magnetic material in addition to a rare earth magnet, for reducing loss and enhancing strength. Thus, it is possible to form a layer having fluorine on the surface of various materials, such as an Fe powder, Fe—Co powder, Fe—Si powder, Fe—C powder, Fe—Al—Si powder, Fe—Si—B powder, and a ribbon using the solution. Since the rare earth magnet having segregated heavy rare earth element near the grain boundary as described above had less deterioration due to processing on the surface, deterioration of magnetic characteristics of a magnet prepared by being severed from a bulk sintered body was less than that of a conventional sintered magnet. It is also possible to further increase the coercive force by having metal elements, such as Ga, Cu, Nb, Mo, Ti, Sn, and Zr, segregated with a heavy rare earth element near the grain boundary described above.

### EXAMPLE 22

A SmCo ally was dissolved using a technique, such as a high-frequency dissolving technique, and ground in an inert gas. The grain size of the ground powder ranged from 1 μm to 10 μm. The ground powder was provided with a fluorine compound precursor (SmF₃ precursor) whose X-ray diffraction peak had a half-value width of 1° or larger coated on the surface, and then dried. The orientation of the coated powder was aligned in a magnetic field using a pressing device to prepare a compact. The powder of the compact had a large number of cracks. By coating the outside of the compact with the fluorine compound precursor, a part of the surface having cracks was also coated with the fluorine compound precursor. Subsequently, the precursor was sintered, and then rapidly cooled. The sintered body consisted of at least 2 phases, on which a SmCo₅ phase and a Sm₂Co₁₇ phase were formed. The fluorine compound, which started to be decomposed at sintering, distributed in both phases. A larger number of fluorine atoms existed in the SmCo₅ phase. A high coercive force was observed in this case compared to the case where no fluorine compound precursor was added. Furthermore, the application of the fluorine compound precursor coating was observed to have any one of the effects including an increase of resistivity, an improvement of squareness, and an improvement of demagnetization resistance. As described in this example, it was possible to adopt a solution treatment for a Co-based magnetic material, and thereby to improve the magnetic characteristics thereof. It was also possible to adopt this method to other materials including the Co-based magnetic material, such as a Co—Si—B-based material, a Co—Fe-based material, a Co—Ni-Fe-based material, and a Co-rare earth element-based material in addition to the SmCo-based material.

### EXAMPLE 23

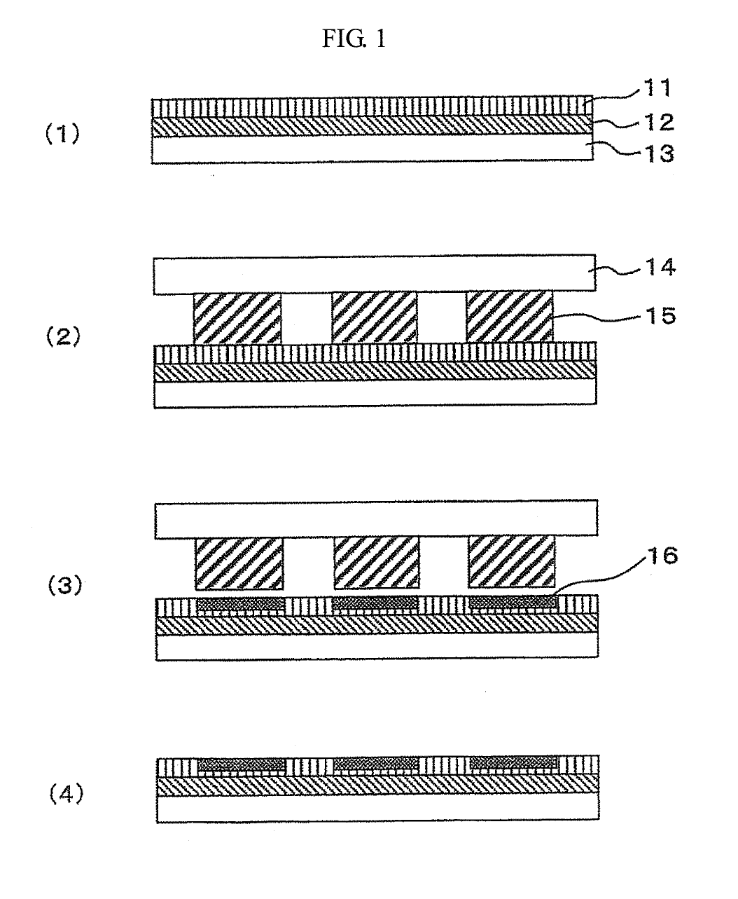

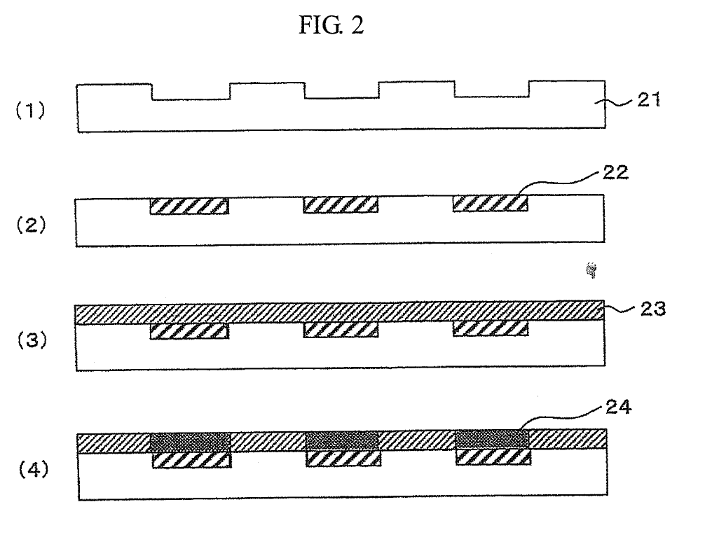

After a foundation layer 12 was formed on a substrate 13 in FIG. 1 using a sputtering method or a vapor-deposition method, an Fe-based magnetic layer 11 was further provided thereon by a physical vapor deposition method or a chemical vapor deposition method. In order to locally heat the Fe-based magnetic layer 11, a substrate 14 having a fluorine compound 15 formed by patterning thereon was placed into contact with or near the Fe-based magnetic layer 11. The fluorine compound 15 was selectively heated by irradiation with, for example, an electromagnetic wave thereby to heat the Fe-based magnetic layer 11 in contact with or close to the fluorine compound 15. Hence, it was possible to change the magnetic characteristics of the Fe-based magnetic layer 11. In the case where an Fe—Pt-based material was used for the Fe-based magnetic layer 11, a heated region 16 was caused to have a regular phase by electromagnetic wave irradiation, resulting in a high coercive force. Since the area having a high coercive force was regulated by adjusting the intervals between the fluorine compounds 15, it was possible to arbitrarily change the proportion between the region having a high coercive force and a region having a low coercive force. Hence, the utilization can be made for a magnetic disk. By having the fluorine compound 15 and an Fe-based magnetic material in contact, and causing the fluorine compound 15 and the Fe-based magnetic layer 11 to react with each other only in the contacting region by electromagnetic wave heating, it was possible to change magnetic characteristics, such as a coercive force, residual magnetic flux density, Curie point (magnetic transformation point), electric resistance, magnetic resistance, and anisotropic energy, in the reaction region only, and it was also possible to add other characteristics, such as an anisotropy direction and exchange coupling, by application of a magnetic field during heating. Furthermore, having grooves provided in advance as shown in FIG. 2, a substrate 21 was provided, in the groove thereon, with a heating part 22 whose temperature was easily raised with an electromagnetic wave on the grooves. During formation of a magnetic layer 23 on the heating part 22, the temperature of the heating part 22 rose due to the electromagnetic wave irradiation, and only a region near the heating part 22 was heated, resulting in formation of a magnetic-characteristics altered region 24 exhibiting the above-described changes in the magnetic characteristics. This process can be adopted to, for example, a device used for a magnetic head and a magnetic disk device, or for an optical device utilizing fluorescent characteristics of the fluorine compound.

### EXAMPLE 24

A preliminary compact was formed by compression molding of particles, which have the main phase near a Nd₂Fe₁₄B composition and a grain size ranging from 1 μm to 20 μm, in a magnetic field. The preliminary compact was heated at a temperature between 500° C. and 1000° C. in an inert gas or in vacuum, and then impregnated in or coated with a fluorine compound cluster solution or colloid solution, whose X-ray diffraction peak had a half-value width of 1° or larger. In this treatment, the fluorine compound precursor solution penetrated along the interface of the magnetic powder in the compact, and therefore a part of the interface was coated with the fluorine compound precursor. In the next step, the compact having impregnated or coated was sintered at temperature higher than the above-described heating temperature, and then further heated at temperature lower than the sintering temperature for improvement of coercive force to obtain a sintered body including fluorine and the constituent element of the precursor, which was a rare earth element, an alkaline element, or an alkaline earth element. The feature of this process is described as follows: upon forming a rare earth element-rich phase in a part or entire surface of the magnetic powder before sintering, and providing a clearance of 1 nm or larger between the magnetic powder and a region not in contact with the magnetic powder by causing incomplete sintering, a fluorine compound precursor penetrates into, and coats, the clearance by the impregnation or coating, and then the fluorine compound precursor coats a part of the surface of the magnetic powder located within, not on the outermost surface of, the compact. This process allowed a fluorine compound cluster to be coated on the surface of the magnetic powder which was located in the center of the sintered body having a size of 100 mm. Hence, by selecting a heavy rare earth element, such as Dy and Tb, for the constituent element of the fluorine compound cluster and then causing segregation of the heavy rare earth element near the crystal grain boundary of the sintered body, it was possible to achieve any of: an increased coercive force; improved squareness; increased residual magnetic flux density; lowered temperature coefficient for coercive force or residual magnetic flux density; and reduced magnetic characteristics deterioration due to processing. The segregation of the heavy rare earth element, which occurred in a region between 1 nm to 100 nm from the crystal grain boundary, varied according to temperature in the thermal treatment, and showed a tendency of spreading out at a distinct point, such as a grain boundary triple point.

### EXAMPLE 25

An Fe-M-F compound (M represents at least one of alkaline elements, alkaline earth elements, and rare earth elements) was formed by mixing an Fe-fluorine compound cluster solution whose X-ray diffraction peak had a half-value width of 1° or larger, with a fluorine compound precursor including at least one of alkaline elements, alkaline earth elements, and rare earth elements, and then by drying and heating the mixture. Since the precursor was mixed, particles growing during the drying and heating treatments were as small as the size ranging from 1 nm to 30 nm. The fluorine compound grew in these nanoparticles. The fluorine compound material having a high coercive force could be prepared by forming an M-rich phase in a composition of at least 10 atomic percent of Fe and at least 1% of fluorine in the grain boundary. To be more specific, upon causing a fluorine-rich phase, an Fe-rich phase, and a M-rich phase to grow in a composition of at least 50 atomic percent of Fe, 5% to 30% of M, and 1% to 20% of fluorine and causing a fluorine-rich phase or an M-rich phase to grow in the grain boundary, it was possible to obtain a ferromagnetic powder having a coercive force of 10 kOe or higher. Since the fluorine compound was caused to grow in a magnetic field to provide anisotropy, the Fe-rich phase grew along the direction of the magnetic field. In the growing process, contamination of hydrogen, oxygen, carbon, nitrogen, or boron did not make any significant difference as long as the structure of the above-described phase was intact. Furthermore, it was possible to obtain a high coercive force (a coercive force of 5 kOe or higher) by causing an Fe-M-F compound (M atom is at least one transition metal element, such as Cr and Mn) having at least 5 atom percent of M atom and at least 5 atom percent of Fe to grow from a solution containing, for example, a fluorine compound in a cluster form. Including the fluorine atom having an anisotropic alignment, the compound thus prepared exhibited high anisotropy. Being formed by use of the solution as described above, such a ternary magnet required no processing and polishing processes; thus, it was possible to easily prepare a magnet having a complicated shape. It was also possible to change the anisotropy direction continuously within a single magnet in this process; thus, the magnet can be adopted to various rotators, magnetic sensors, magnetic parts for hard disk, and magnetic media. In addition, the Fe-M-F ternary alloy can be altered to be a soft magnetic material having a highly-saturated magnetic flux density when prepared with a concentration of the M atom below 5 atom percent; thus, the alloy can be adopted as a core material for various magnetic circuits. Such a magnetic material can be obtained with, in addition to the Fe-M-F as above, Fe—Co-M-F-based, Co-M-F-based, and Ni-M-F-based compounds. In the process, both magnetic characteristics, soft and hard, were achieved according to the F composition and crystalline structure. Thus, it was possible to prepare a hard magnetic material, in which both soft and hard magnetic characteristics coexisted, and in which the soft and hard magnetic materials were connected to each other through a ferromagnetic bond, by using a solution. Furthermore, it was possible to prepare a magnetic material having both optical and magnetic characteristics from the magnetic material including at least 10 atomic percent of F; thus, such a ferromagnetic magnetic material having fluorescent or absorption characteristics and magnetic characteristics can be adopted to a device utilizing magnetism or an optical device.

### EXAMPLE 26

In the case of preparing a rotator by processing and polishing a NdFeB-based sintered magnet having a Nd₂Fe₁₄B structure in the main phase, and by attaching the sintered magnet to a layered electromagnetic steel plate, a layered amorphous or an iron powder compact, the position of the layered electromagnetic steel plate or iron powder compact where a magnet was to be inserted was processed in advance by using, for example, a metal mold. When the sintered magnet was inserted in the magnet insertion position, a clearance ranging from 0.01 mm to 0 5 mm was provided between the sintered magnet and the layered electromagnetic steel plate or the iron powder compact. After the sintered magnet in any shape including a rectangular shape, a ring shape, and a curbed shape such as a halved cylinder shape, was inserted into the magnet position having such a clearance, the clearance was filled with a fluorine compound solution in a gel, sol, or cluster form. The sintered magnet and the layered electromagnetic steel plate, layered amorphous, or iron powder compact were attached to each other by heating at temperature of 100° C. or higher. In this process, further heating at temperature of 500° C. or higher caused the rare earth element or fluorine to diffuse into the surface of the sintered magnet, and also caused the constituent element of the fluorine compound to diffuse into the surface of the layered electromagnetic steel plate or iron powder compact; thus, it was possible to improve magnetic characteristics of the sintered magnet (for example, an improved coercive force, improved squareness, increased demagnetization resistance, and raised Curie temperature), and also to strengthen the attachment. It was possible to improve the magnetic characteristics of a curbed process-affected layer of the sintered magnet. A light element, such as oxygen and carbon, may be included on the surface of the individual magnetic materials and in a diffusion layer, in the grain boundary, having the fluorine or rare earth element as the main component. For improvement of the magnetic characteristics of the sintered magnet, the rare earth element is provided to the fluorine compound. For other effects, such as attachment effect, removal of the magnetostrictive property of soft magnetism, or loss reduction, than improvement in the magnetic characteristics of the magnet, a fluorine compound including the rare earth element, alkaline element and/or alkaline earth element can be used.

### EXAMPLE 27

A fluorine compound solution was coated to or mixed with an oxide particulate having at least one of the elements including Fe, Co, and Ni. The solution having an alcohol based solvent included a fluorine compound in a gel or sol form. The oxide particulate having a diameter ranging from 1 nm to 10,000 nm may be amorphous, globular, or flat in form. Such a particulate mainly composed of the oxide was brought in contact on the surface thereof with the solution, and then heated. An element, such as Sr and La, may be added in advance on the oxide particulate. Heating at a temperature ranging from 500° C. to 1500° C. caused diffusion or reaction between the fluorine compound and the oxide, and also caused a part thereof to become an oxide-fluorine compound. The diffusion of the constituent element of the oxide and the constituent element of the fluorine compound provided a crystal having a large anisotropic energy. This crystal was an oxide-fluorine compound having at least 1 atomic percent of fluorine, and a large anisotropic energy was also obtained with the mixture of the oxide-fluorine compound and the oxide. Such an oxide-fluorine compound had a residual magnetic flux density ranging from 0.5 T to 1.0 T and a coercive force ranging from 5 kOe to 10 kOe; thus, it was possible to achieve a higher residual magnetic flux density than that of a conventional ferrite magnet. No significant deterioration in magnetic characteristics was observed due to the presence of nitrogen and/or carbon in the oxygen-fluorine compound. Having a specific resistance of 1×10² Ωcm or higher, the oxygen-fluorine compound has a small eddy current loss, and therefore can be adopted to a magnetic circuit using a high-frequency magnetic field. As described above, the oxide reacted with the fluorine atom or the rare earth element or alkaline element included in the fluorine compound to reduce temperature dependence of magnetic characteristics as well as to provide a large anisotropic energy and an increased coercive force. The following effects by the reaction in addition to increasing the coercive force were observed: an increase of a residual magnetic flux density; reduction of a temperature coefficient of coercive force; improvement of squareness of a demagnetization curve; increase of magnetooptical effects, such as an increased Kerr rotation angle; increase of magnetic resistance; expression of thermoelectric effects; and increase of magnetic refrigeration effect.

### EXAMPLE 28

A treating solution for forming a rare earth fluoride or alkaline earth metal fluoride coating film was prepared according to the following steps.
(1) 4 g of salt having a high solubility to water, such as lanthanum acetate or lanthanum nitrate for La, was added to 100 ml of water, and dissolved completely using a shaker or an ultrasonic stirrer.
(2) HF diluted to 10% was gradually added in an equivalent amount for a chemical reaction to generate LaF (x=1 to 3).
(3) The solution in which a gelled precipitation of LaF (x=1 to 3) was generated was stirred for 1 hour or longer using an ultrasonic stirrer.
(4) After the solution was centrifuged at a speed ranging from 4,000 to 6,000 rpm, the supernatant was removed, and methanol was added at an amount approximately equivalent to the removed supernatant.
(5) After the methanol solution containing a gelled LaF cluster was stirred thoroughly to obtain a suspension, the suspension was stirred with an ultrasonic stirrer for one hour or longer.
(6) The steps (4) and (5) were repeated three to ten times until no anion, such as acetate ion and nitrate ion, was detected.
(7) In the case of LaF system, almost transparent LaF in a sol form was obtained. The methanol solution containing 1 g of LaF per 5 ml of the solution was adopted as the treating solution.
(8) An organic metal compound listed in Table 2, except for carbon, was added to the solution.

It was also possible to prepare the other treating solutions for forming a coating film mainly containing a rare earth fluoride or alkaline earth metal fluoride by following the almost same steps as described above. Even if being added with various elements, the fluorine-based treating solutions containing Dy, Nd, La, and Mg, as shown in Table 2, did not exhibit a diffraction pattern corresponding with that of a fluorine compound expressed as REₙFₘ (RE represents a rare earth element or an alkaline earth element; n and m represent positive numbers), an oxygen-fluorine compound, or a compound with an additive element. The solution structure was not largely changed by the additive element in the content range shown in Table 2. It was observed that the diffraction pattern of the solution or a film formed by drying the solution included multiple peaks each having a half-value width of 1° or larger. This indicated that the treating solution was different from that of REₙFₘ in terms of an interatomic distance between the additive element and fluorine or between the metal elements, and also in terms of crystalline structure. Since the half-value width was 1° or larger, the interatomic distance of the treating solution had a certain distribution, unlike a normal metal crystal having a constant interatomic distance. Such a distribution was caused by the presence of other atoms, mainly of hydrogen, carbon, and oxygen, located around the metal element or fluorine element atom. The application of an external energy, such as heat, caused these atoms, such as hydrogen, carbon, and oxygen, to easily migrate, and thereby changed the structure and fluidity. The X-ray diffraction patterns of the sol and gel, whose peak had a half-value width larger than 1°, exhibited a structural change by a thermal treatment, and a part of a diffraction pattern of the REₙFₘ or REₙ(F, O)ₘ appeared. It was assumed that a majority of the additive elements listed in Table 2 also had no long-period structure in the solutions. The diffraction peak of the REₙFₘ had a narrower half-value width than that of the diffraction peak of the sol or gel. In order to obtain a coating film having a uniform thickness by increasing the fluidity of the solution, it was important to have at least one peak having a half-value width of 1° or larger in the diffraction peak of the solution. Such a peak having a half-value width of 1° or larger, and the diffraction pattern of the REₙFₘ or a peak of an oxygen-fluorine compound may be included in the diffraction pattern of the solution. In the case where only the diffraction pattern of the REₙFₘ or the oxygen-fluorine compound was observed, or where a diffraction pattern having 1° or smaller was observed, mainly in the diffraction pattern of the solution, it was difficult to provide a uniform coating due to poor fluidity caused by the presence of solid phase, not in a sol or gel form, in the solution. The treating solution was applied to a sintered block as follows.
(9) A block of NdFeB sintered body (10 mm×10 mm×10 mm) was immersed in the treating solution for forming a LaF-based coating film, and then the block was placed under a reduced pressure of 2 to 5 Torr for removal of the solvent methanol.
(10) The step (9) was repeated 1 to 5 times, and the block was heated at a temperature ranging from 400° C. to 1,100° C. for 0.5 hours to 5 hours.
(11) A pulsed magnetic field of 30 kOe or stronger was applied to the anisotropic magnet provided with a surface coating film in the step (10) in the anisotropy direction.

A demagnetization curve of the magnetized compact was measured by placing the compact between the magnetic poles of a DC M-H loop measurement device such that the magnetization direction of the compact agreed with the direction of the applied magnetic field, and then applying the magnetic field between the magnetic poles. The magnetic pole pieces for the application of the magnetic field to the magnetized compact were made of an FeCo alloy. The values of magnetization were corrected using a pure Ni sample and a pure Fe sample having the same shape.

As a result, the block of NdFeB sintered body having the rare earth fluoride coating film formed thereon and sequentially heated acquired an increased coercive force. With no additive element, the coercive forces of sintered magnets having fluoride or fluorine-oxygen compound containing Dy, Nd, La, and Mg segregated therein were increased by 30%, 25%, 15%, and 10%, respectively. The sintered magnet block before being immersed in the treating solution had a coercive force (iHc) ranging from 10 kOe to 35 kOe and a residual magnetic flux density ranging from 1.2 T to 1.55 T. Having the magnetic characteristics in these ranges, it was possible to observe an increase of coercive force in the above-described levels. The reduction of residual magnetic flux density after the increase of coercive force in the sintered magnet block was higher than that of a sintered magnet prepared in a process involving no diffusion treatment. In order to further increase the coercive force which had already been increased by the coating with the solution having no additive element and by the heating, the additive elements listed in Table 2 were added to the fluoride solutions using an organic metal compound. Compared to the coercive force of the solution having no additive element as a reference, the coercive force of the sintered magnet was further increased by the additive elements listed in Table 2 added to the solution; thus, it was revealed that these additive elements contributed to the increase of a coercive force. The percentage increases in coercive force are shown in Table 2. It was possible to increase the coercive force, and, at the same time, to conduct the diffusion treatment involving no reduction of residual magnetic flux density by controlling the kind and concentration of additive elements, the conditions and distance of diffusion, and the magnetic structure of a grain boundary phase. It was also possible to have a residual magnetic flux density equivalent to or higher than that before the treatment, and, at the same time, to improve energy product by 10% to 30%. In the vicinity of the element added to the solution, a short-range structure was observed due to the removal of the solvent. Further heating caused the element to diffuse together with the constituent element of the solution along the grain boundary of the sintered magnet. The additive elements showed a tendency of segregating together with some of the constituent elements of the solution near the grain boundary. In other words, the additive elements listed in Table 2 diffused together with at least one of fluorine, oxygen, and carbon into the sintered magnet, and some of the elements stayed near the grain boundary. In the sintered magnet exhibiting a high coercive force, the concentration of the constituent element of the fluoride solution showed a tendency of being high in the periphery of the magnet and low at the center thereof. This is because, while the fluoride, fluoride carbonate, carbon-fluoride, or oxygen-fluoride including the additive element and having the short-range structure grew on the outer surface of the sintered magnet block which had been coated with the fluoride solution including the additive element and then which had been dried, the additive element continued to diffuse along the grain boundary. Hence, the sintered magnet block exhibited a concentration gradient or concentration difference, from the periphery to the inside of the block, of the fluorine and at least one of the additive elements listed in Table 2. The content of the additive elements shown in Table 2 was approximately consistent with the range in which the solutions retained the optical transparencies. It was also possible to prepare a solution containing higher concentration of additive element, and thus to further increase the coercive force. When an element from the elements listed in Table 2 was added to any one of a fluoride, oxide, fluoride carbonate, carbon-fluoride, and oxygen-fluoride including at least one rare earth element in a slurry form, the improvement in magnetic characteristics, such as high coercive force compared to the case of providing no additive element, was also observed. When the additive element having a concentration more than 100 times higher than that shown in Table 2 was added, the structure of the fluoride composing the solution was changed, resulting in a nonuniform distribution of the additive element in the solution, which tended to inhibit diffusion of other elements. Thus, it became difficult to cause the additive element to segregate along the grain boundary to reach the inside of the magnet block; however, an increase of a coercive force was locally observed. The additive elements, including carbon, listed in Table 2 have any of the following roles: 1) to reduce an interface energy by segregating near a grain boundary; 2) to increase the lattice matching of a grain boundary; 3) to reduce defects of a grain boundary; 4) to promote grain boundary diffusion of a rare earth element and the like; 5) to increase a magnetic anisotropic energy near a grain boundary; and 6) to smooth the interface with a fluoride or an oxygen-fluoride. As a result, the process of coating a solution with the additive elements listed in Table 2 followed by the diffusion and heating processes provided any of the following effects: an increase of coercive force; improvement of squareness of a demagnetization curve; increase of residual magnetic flux density; improvement of energy product; raise of Curie temperature; reduction of magnetic field for magnetization; reduction in temperature dependence of coercive force and residual magnetic flux density; enhancement of corrosion resistance; increase of specific resistance; and decrease of thermal demagnetization rate. The concentration distribution of the additive elements listed in Table 2 shows that the concentration tended to go down averagely from the peripheral to the inside of the sintered magnet, and that the concentration was high in a grain boundary region. The widths of an area near a grain boundary triple point and of an area distant from the grain boundary triple point tended to be different, and the width of the area near the grain boundary triple point tended to be wider. The additive elements listed in Table 2 were likely to segregate in a grain boundary phase, at the edge of the grain boundary, or in the outer edge in the grain from the grain boundary towards the interior of the grain (grain boundary side). The improvement in magnetic characteristics of the magnet was observed with the following additive elements in the solution: Mg, Al, Si, Ca, Ti, V, Cr, Mn, Fe, Co, Ni, Cu, Zn, Ga, Ge, Sr, Zr, Nb, Mo, Pd, Ag, In, Sn, Hf, Ta, W, Ir, Pt, Au, Pb, and Bi, which are listed in Table 2; and elements selected from elements of the atomic numbers from 18 to 86 which include all the transition metal elements. The sintered magnet exhibited a concentration gradient of the fluorine and at least one of the above-listed elements. Since these additive elements were caused to diffuse by heating after being treated with the solution, they were highly concentrated in the vicinity of the grain boundary where the fluorine segregated, unlike the composition distribution of element added to the sintered magnet in advance. The pre-added element segregated near the grain boundary (a region within 1,000 nm on average from the center of the grain boundary) where little segregation of fluorine occurred. Thus, an averaged concentration gradient was observed from the outermost surface of the magnet block to the inside thereof. When the concentration of additive element was low in the solution, the concentration gradient or concentration difference were observed. As described above, when a magnet block was coated with a solution including an additive element, and then heated for improvement of the characteristics of a sintered magnet, the sintered magnet thus obtained exhibited the following characteristics: 1) a concentration gradient or an averaged concentration difference of the elements listed in Table 2 or the elements of the atomic numbers from 18 to 86 including the transition metal elements was observed from the outermost surface of the sintered magnet to the inside thereof; 2) the segregation of the elements listed in Table 2 or the elements of the atomic numbers from 18 to 86 including the transition metal elements near the grain boundary was observed upon involving fluorine in many cases; 3) the concentration of fluorine was high in the grain boundary phase, while low on the outside of the grain boundary phase, the segregation of the elements listed in Table 2 or the element of the atomic numbers from 18 to 86 was observed near the region where the fluorine concentration difference was observed, and an averaged concentration gradient and/or concentration difference was observed from the surface of the magnet block toward the inside thereof; 4) the highest concentration of the fluorine and additive element was observed on the outermost surface of the sintered magnet block, magnet powder, or ferromagnetic powder, which was coated with the solution, and a concentration gradient or a concentration difference of the additive element was observed from the outer edge in the magnetic body part to the inside thereof; and 5) at least one constituent element of the solution including the additive elements listed in Table 2 or the element of the atomic numbers from 18 to 86 had a concentration gradient from the surface to the inside, the highest fluorine concentration was observed near the interface between the magnet grown out of the solution and the film containing fluorine or on the outside of the interface viewed from the magnet side, and the fluoride near the interface included oxygen or carbon, contributing to any of high corrosion resistance, high electric resistance, or high magnetic characteristics. In the film containing fluorine, at least one of the additive elements listed in Table 2 and the elements of the atomic numbers from 18 to 86 was detected. A large amount of these additive elements was contained near the diffusion path of fluorine in the magnet. Therefore, any of the following effects were observed: an increase of coercive force; improvement of squareness of a demagnetization curve; increase of residual magnetic flux density; improvement of energy product; raise of Curie temperature; reduction of magnetic field for magnetization; reduction in temperature dependence of coercive force and residual magnetic flux density; enhancement of corrosion resistance; increase of specific resistance; and decrease of thermal demagnetization rate. Concentration difference of the additive elements can be examined on the basis of an EDX (energy dispersive X-ray) profile obtained by transmission electron microscopy or by analyzing a sintered block cut from the surface towards the inside using an analytical method, such as EPMA (electron probe X-ray microanalysis) and ICP (inductively coupled plasma) analysis. Segregation of the elements of the atomic numbers from 18 to 86 added to the solution in the vicinity of a fluorine atom (a region within 2,000 nm, preferably 1,000 nm, from the site of fluorine atom segregation) can be analyzed on the basis of an EDX profile obtained by transmission electron microscopy or using EELS (electron energy-loss spectroscopy). The ratio, at an inside position at least 100 μm distant from the magnet surface, between the additive element segregated in the vicinity of the fluorine atom and the additive element located in a part at least 2,000 nm distant from the site of segregation of the fluorine atom ranges from 1.1 to 1,000, preferably 2 or higher. On the surface of the magnet, the ratio was 2 or higher. The additive elements, which segregated either continuously or discontinuously along the grain boundary and did not necessarily segregate throughout the grain boundary, were likely to segregate discontinuously in the center side of the magnet. Some of the additive elements were averagely incorporated into the mother phase without segregating. The concentration of the additive elements of the atomic numbers from 18 to 86 segregating in the vicinity of the fluorine segregation site tended to become lower from the surface of the sintered magnet to the inside thereof. Due to such a concentration distribution, the coercive force tended to be higher near the surface of the magnet than that in the inside thereof. The same improvement in magnetic characteristics as that described above was obtained not only for the sintered magnetic block, but also for a NdFeB-based magnetic powder, the surface of which was provided with a film containing fluorine and any of the additive elements using any of the solutions listed in Table 2 and then heated for diffusion. Hence, it was possible to prepare a sintered magnet by impregnating a preliminary compact formed after preliminary molding a NdFeB powder in a magnetic field into any of the solution listed in Table 2 and then sintering the preliminary compact, or by sintering, together with a preliminary compact in a magnetic field, a mixture of a NdFeB-based powder having the surface treated with any of the solutions listed in Table 2 and an untreated NdFeB-based powder. Although having averagely uniform distributions of concentrations of the solution constituent elements, such as fluorine and additive elements included in the solution, such a sintered magnet has improved magnetic characteristics due to the averagely high concentration of any of the additive elements listed in Table 2 in the vicinity of the diffusion path of the fluorine atom.

TABLE 2

| | Dy-fluoride segregated | | Nd-fluoride segregated | | La-fluoride segregated | | Mg-fluoride segregated | |
|---|---|---|---|---|---|---|---|---|
| | sintered magnet | | sintered magnet | | sintered magnet | | sintered magnet | |
| | Content in | Percentage | Content in | Percentage | Content in | Percentage | Content in | Percentage |
| | DyF-based | of coercive | NbF-based | of coercive | LaF-based | of coercive | MgF-based | of coercive |
| | solution | force | solution | force | solution | force | solution | force |
| | (Dy ratio) | increase (%) | (at %) | increase (%) | (at %) | increase (%) | (at %) | increase (%) |
| C | 10-5000 | 5 | 10-5000 | 6 | 10-5000 | 6 | 0.1-30 | 8 |
| | (solvent) | | (solvent) | | (solvent) | | | |
| Mg | 0.0001-0.1 | 7 | 0.001-10.5 | 5 | 0.0001-3.5 | 7 | — | — |
| Al | 0.0001-0.2 | 12 | 0.0001-15.0 | 9 | 0.0001-5.0 | 12 | 0.0001-5.0 | 11 |
| Si | 0.0001-0.05 | 10 | 0.0001-10.5 | 5 | 0.0001-5.5 | 5 | 0.0001-5.5 | 6 |
| Ca | 0.0001-1.0 | 8 | 0.0001-5.5 | 7 | 0.0001-1.0 | 13 | 0.0001-1.0 | 5 |
| Ti | 0.0001-1.0 | 12 | 0.0001-7.0 | 9 | 0.0001-2.5 | 12 | 0.0001-2.5 | 7 |
| V | 0.0001-1.0 | 14 | 0.0001-3.5 | 11 | 0.0001-1.5 | 8 | 0.0001-1.5 | 4 |
| Cr | 0.0001-1.0 | 11 | 0.0001-5.5 | 13 | 0.0001-2.0 | 9 | 0.0001-2.0 | 6 |
| Mn | 0.0001-1.0 | 17 | 0.0001-10.5 | 18 | 0.0001-5.0 | 15 | 0.0001-5.0 | 8 |
| Fe | 0.0001-1.0 | 5 | 0.0001-7.0 | 6 | 0.0001-7.0 | 11 | 0.0001-7.0 | 7 |
| Co | 0.0001-1.0 | 21 | 0.0001-20.5 | 29 | 0.0001-10.0 | 22 | 0.0001-10.0 | 13 |
| Ni | 0.0001-1.0 | 15 | 0.0001-15.5 | 17 | 0.0001-10.0 | 17 | 0.0001-10.0 | 9 |
| Cu | 0.0001-1.0 | 35 | 0.0001-10.0 | 33 | 0.0001-10.0 | 15 | 0.0001-10.0 | 17 |
| Zn | 0.0001-1.0 | 14 | 0.0001-10.0 | 17 | 0.0001-7.0 | 18 | 0.0001-7.0 | 18 |
| Ga | 0.0001-1.0 | 27 | 0.0001-15.0 | 25 | 0.0001-15.0 | 22 | 0.0001-15.0 | 27 |
| Ge | 0.0001-1.0 | 24 | 0.0001-13.5 | 21 | 0.0001-12.0 | 20 | 0.0001-12.0 | 15 |
| Sr | 0.0001-1.0 | 14 | 0.0001-3.5 | 14 | 0.0001-5.0 | 11 | 0.0001-5.0 | 9 |
| Zr | 0.0001-1.0 | 25 | 0.0001-17.5 | 21 | 0.0001-12.0 | 9 | 0.0001-12.0 | 7 |
| Nb | 0.0001-1.0 | 23 | 0.0001-15.0 | 25 | 0.0001-10.0 | 6 | 0.0001-10.0 | 4 |
| Mo | 0.0001-1.0 | 19 | 0.0001-10.8 | 10 | 0.0001-5.5 | 14 | 0.0001-5.5 | 11 |
| Pd | 0.0001-1.0 | 28 | 0.0001-25.5 | 27 | 0.0001-15.0 | 18 | 0.0001-15.0 | 13 |
| Ag | 0.0001-1.0 | 33 | 0.0001-15.5 | 25 | 0.0001-15.5 | 21 | 0.0001-15.5 | 17 |
| In | 0.0001-1.0 | 27 | 0.0001-15.5 | 17 | 0.0001-10.2 | 23 | 0.0001-10.2 | 16 |
| Sn | 0.0001-1.0 | 28 | 0.0001-4.4 | 15 | 0.0001-5.0 | 26 | 0.0001-5.0 | 18 |
| Hf | 0.0001-1.0 | 15 | 0.0001-7.5 | 12 | 0.0001-5.2 | 12 | 0.0001-5.2 | 5 |
| Ta | 0.0001-1.0 | 19 | 0.0001-8.5 | 5 | 0.0001-5.5 | 8 | 0.0001-5.5 | 3 |
| W | 0.0001-1.0 | 11 | 0.0001-12.5 | 8 | 0.0001-2.0 | 4 | 0.0001-2.0 | 2 |
| Ir | 0.0001-1.0 | 17 | 0.0001-15.5 | 12 | 0.0001-1.5 | 15 | 0.0001-1.5 | 6 |
| Pt | 0.0001-1.0 | 41 | 0.0001-25.5 | 32 | 0.0001-10.0 | 27 | 0.0001-10.0 | 14 |
| Au | 0.0001-1.0 | 31 | 0.0001-4.8 | 24 | 0.0001-8.0 | 22 | 0.0001-8.0 | 3 |
| Pb | 0.0001-1.0 | 12 | 0.0001-1.5 | 15 | 0.0001-5.0 | 10 | 0.0001-5.0 | 5 |
| Bi | 0.0001-1.0 | 28 | 0.0001-20.5 | 21 | 0.0001-10.6 | 9 | 0.0001-10.6 | 8 |

### EXAMPLE 29

A rare earth permanent magnet, which was a sintered magnet, was obtained by causing a fluorine atom and a G component (G represents at least one element selected from each of transition metal elements and rare earth elements, or at least one element selected from each of transition metal elements and alkaline earth metal elements) to diffuse into an R—Fe—B-based sintered magnet (R represents a rare earth element) from the surface thereof. The composition of the rare earth permanent magnet is expressed by one of the following composition formulae (1) and (2):

RₐG_{b}T_{c}A_{d}FₑO_{f}M_{g} (1)

(R.G)_{a+b}T_{c}A_{d}FₑO_{f}M_{g} (2)

(In these formulae: R represents at least one element selected from rare earth elements; M represents the elements of Groups from 2 to 16, excluding the rare earth element existing within the sintered magnet before the coating of a solution containing fluorine, and also excluding C and B; and G represents at least one element selected from each of transition metal elements and rare earth elements, or at least one element selected from each of transition metal elements and alkaline earth metal elements. R and G may contain the same element. The formula (1) expresses the composition of the magnet in which R and G do not contain the same element, while the formula (2) expresses the composition of the magnet in which R and G contain the same element. T represents one or two elements selected from Fe and Co, and A represents at least one selected from B (boron) and C (carbon). Lower-case letters a to g represent atomic percents in the alloy: in the formula (1), 10≦a≦15, 0.005≦b≦2; and, in the formula (2), 10.005≦a+b≦17, 3≦d≦15, 0.01≦e≦4, 0.04≦f≦4, 0.01≦g≦11, and the rest is c.) In the rare earth permanent magnet, at least one of the constituent elements F and transition metal elements had a distribution in which the concentration averagely becomes higher from the center of the magnet to the surface thereof. The rare earth permanent magnet also has an averagely higher G/(R+G) concentration in the crystal grain boundary surrounding the main phase crystal grain composed of tetragonal (R, G)₂T₁₄A than that in the main phase crystal grain. Moreover, the rare earth permanent magnet includes an oxygen-fluoride, fluoride, or fluoride carbonate of R and G in the region of the crystal grain boundary at least 10 μm distant in depth from the magnet surface. Furthermore, the rare earth permanent magnet has a higher coercive force near the magnet surface than that in the inside thereof. As one of the characteristics, a gradient of transition metal element concentration is observed from the surface of the sintered magnet towards the center thereof. The rare earth permanent magnet can be prepared according to the following method, for example.

A treating solution for forming a rare earth fluoride or alkaline earth metal fluoride coating film added with a transition metal element was prepared according to the following steps.
(1) 4 g of salt having a high solubility to water, such as dysprosium acetate or dysprosium nitrate for Dy, was added to 100 ml of water, and dissolved completely using a shaker or an ultrasonic stirrer.
(2) HF diluted to 10% was gradually added in an equivalent amount for a chemical reaction to generate DyFₓ (x=1 to 3).
(3) The solution in which a gelled precipitation of DyFₓ (x=1 to 3) was generated was stirred for 1 hour or longer using an ultrasonic stirrer.
(4) After the solution was centrifuged at a speed ranging from 4,000 to 6,000 rpm, the supernatant was removed and methanol was added at an amount approximately equivalent to the removed supernatant.
(5) After the methanol solution containing a gelled DyF cluster was stirred thoroughly to a suspension, the suspension was stirred with an ultrasonic stirrer for one hour or longer.
(6) The steps (4) and (5) were repeated three to ten times until no anion, such as acetate ion and nitrate ion, was detected.
(7) In the case of DyF system, almost transparent DyFₓ in a sol form was obtained. The methanol solution containing 1 g of DyFₓ per 5 ml of the solution was adopted as the treating solution.
(8) An organic metal compound listed in Table 2, except for carbon, was added to the solution.

It was also possible to prepare the other treating solutions used for forming a rare earth fluoride or alkaline earth metal fluoride coating film by following the almost same steps as described above. Even if being added with various elements, the fluorine-based treating solutions containing Dy, Nd, La, and Mg, as shown in Table 2, did not exhibit a diffraction pattern corresponding with that of a fluorine compound or an oxygen-fluorine compound expressed as REₙFₘ (RE represents a rare earth element or an alkaline earth element; n and m represent positive numbers) or REₙFₘOₚCᵣ (RE represents a rare earth element or an alkaline earth element; O, C, and F represent oxygen, carbon, and fluorine, respectively; n, m, p, and r are positive numbers), respectively, or a compound with an additive element. The solution structure was not largely changed by the additive element in the content range shown in Table 2. It was observed that the diffraction pattern of the solution or a film formed by drying the solution included multiple peaks each having a half-value width of 1° or larger. This indicated that the treating solution was different from that of the REₙFₘ in terms of an interatomic distance between the additive element and fluorine, or between the metal elements, and also in terms of crystalline structure. Since the half-value width was 1° or larger, the interatomic distance of the treating solution had a certain distribution, unlike a normal metal crystal having a constant interatomic distance. Such a distribution was caused by the presence of other atoms, mainly including hydrogen, carbon, and oxygen, located differently from those in the above-mentioned compounds, around the metal element or fluorine element atom. The application of an external energy, such as heat, caused these atoms, such as hydrogen, carbon, and oxygen, to easily migrate, and thereby changed the structure and fluidity. The X-ray diffraction patterns of the sol and the gel, whose peaks had a half-value width larger than 1°, exhibited a structural change by a thermal treatment, and a part of a diffraction pattern of the REₙFₘ or REₙ(F, O)ₘ appeared. The additive elements listed in Table 2 had no long-period structure in the solutions. The diffraction peak of the REₙFₘ had a narrower half-value width than that of the diffraction peak of the sol or gel. In order to obtain a coating film having a uniform thickness by increasing the fluidity of the solution, it was important to have at least one peak having a half-value width of 1° or larger in the diffraction pattern of the solution. Such a peak having a half-value width of 1° or larger, and the diffraction pattern of the REₙFₘ or a peak of an oxygen-fluorine compound may be included in the diffraction pattern of the solution. In the case where only the diffraction pattern of the REₙFₘ or the oxygen-fluorine compound was observed, or where a diffraction pattern having 1° or smaller was observed, mainly in the diffraction pattern of the solution, the presence of solid phase, not in a sol or gel form, in the solution resulted in poor fluidity; however, an increase of a coercive force was observed.
(9) A block of NdFeB sintered body (10 mm×10 mm×10 mm) was immersed in the treating solution for forming a DyF-based coating film, and then the block was placed under a reduced pressure of 2 to 5 Torr for removal of the solvent methanol.
(10) The step (9) was repeated 1 to 5 times, and the block was heated at a temperature ranging from 400° C. and 1100° C. for 0.5 hours to 5 hours.
(11) A pulsed magnetic field of 30 kOe or stronger was applied to the anisotropic magnet provided with a surface coating film in the step (10) in the anisotropy direction.

A demagnetization curve of the magnetized compact was measured by placing the compact between the magnetic poles of a DC M-H loop measurement device such that the magnetization direction of the compact agreed with the direction of the applied magnetic field, and then applying the magnetic field between the magnetic poles. The magnetic pole pieces for the application of the magnetic field to the magnetized compact were made of an FeCo alloy. The values of magnetization were corrected using a pure Ni sample and a pure Fe sample having the same shape.

As a result, the block of NdFeB sintered body having the rare earth fluoride coating film formed thereon acquired an increased coercive force. By using the treating solution added with the transition metal element, the sintered body acquired a higher coercive force than that of a sintered magnet having no additive element. Such a further increase of the coercive force which had already been increased by the coating of the solution with no additive element and by the subsequent thermal treatment, indicated that these additive elements contributed to the increase of coercive force. In the vicinity of the element added to the solution, a short-range structure was observed due to the removal of the solvent. Further heating caused the element to diffuse together with the constituent element of the solution along the grain boundary of the sintered magnet. The additive element showed a tendency of segregating together with some of the constituent elements of the solution near the grain boundary. In the sintered magnet exhibiting a high coercive force, the concentration of the constituent element of the fluoride solution showed a tendency of being high in the periphery of the magnet and low at the center thereof. This is because, while the fluoride or oxygen-fluoride including the additive element and having the short-range structure grew on the outer surface of the sintered magnet block which had been coated on the outer surface with the fluoride solution including the additive element and then which had been dried, the additive element continued to diffuse along the vicinity of the grain boundary. Hence, the sintered magnet block exhibited a concentration gradient, from the periphery to the inside of the block, of the fluorine and at least one of the additive elements listed in Table 2. The content of the additive elements shown in Table 2 was approximately consistent with the range in which the solutions retained the optical transparencies. It was also possible to prepare a solution containing higher concentration of additive element. When any element of the atomic numbers from 18 to 86 was added to one of a fluoride, oxide, and oxygen-fluoride including at least one rare earth element in a slurry form, the improvement in magnetic characteristics, such as high coercive force compared to the case of providing no additive element, was observed. The additive elements have any of the following roles: 1) to reduce an interface energy by segregating near a grain boundary; 2) to increase the lattice matching of a grain boundary; 3) to reduce defects of a grain boundary; 4) to promote grain boundary diffusion of a rare earth element and the like; 5) to increase a magnetic anisotropic energy near a grain boundary; 6) to smooth the interface with a fluoride, an oxygen-fluoride, or a fluoride carbonate; 7) to increase anisotropy of a rare earth element; 8) to remove oxygen from the mother phase; and 9) to raise a Curie temperature of the mother phase. As a result, any of the following effects were observed: an increase of coercive force; improvement of squareness of a demagnetization curve; increase of residual magnetic flux density; improvement of energy product; raise of Curie temperature; reduction of magnetic field for magnetization; reduction in temperature dependence of coercive force and residual magnetic flux density; enhancement of corrosion resistance; increase of specific resistance; and decrease of thermal demagnetization rate. The concentration distribution of the transition metal elements including the additive elements listed in Table 2 showed that the concentration tended to go down averagely from the peripheral of the sintered magnet to the inside thereof, and that the concentration was high in a grain boundary region. The widths of an area near a grain boundary triple point and of an area distant from the grain boundary triple point tended to be different, and the width of the area near the grain boundary triple point tended to be wider and more concentrated. The transition metal additive elements were likely to segregate in a grain boundary phase, at the edge of the grain boundary, or in the outer edge in the grain from the grain boundary towards the interior of the grain (grain boundary side). Since these additive elements were caused to diffuse by heating after being treated with the solution, they were highly concentrated in the vicinity of the grain boundary where the fluorine or rare earth element segregates, unlike the composition distribution of element added to the sintered magnet in advance. The pre-added element segregated in the grain boundary where little segregation of fluorine occurred. Thus, an averaged concentration gradient was observed from the outermost surface of the magnet block to the inside thereof. When the concentration of additive element was low in the solution, the concentration gradient or concentration difference were observed. As described above, when a magnet block was coated with a solution including an additive element, and then heated for improvement of the characteristics of a sintered magnet, the sintered magnet thus obtained exhibited the following characteristics: 1) a concentration gradient or an averaged concentration difference of the transition metal element was observed from the outermost surface of the sintered magnet to the inside thereof; 2) the segregation of the transition metal element near the grain boundary was observed upon involving fluorine; 3) the concentration of fluorine was high in the grain boundary phase, while low on the outside of the grain boundary phase, the segregation of the transition metal element was observed near the region where the fluorine concentration difference was observed, and an averaged concentration gradient and/or concentration difference was observed from the surface of the magnet block toward the inside thereof; and 4) a layer containing the transition metal element, fluorine, and carbon grew on the outermost surface of the sintered magnet.

### EXAMPLE 30

A rare earth permanent magnet, which was a sintered magnet, was obtained by causing a fluorine atom and a G component (G represents at least one element selected from each of transition metal elements and rare earth elements, or at least one element selected from each of transition metal elements and alkaline earth metal elements) to diffuse into an R—Fe—B-based sintered magnet (R represents a rare earth element) from the surface thereof. The composition of the rare earth permanent magnet is expressed by one of the following composition formulae (1) and (2):

RₐG_{b}T_{c}A_{d}FₑO_{f}M_{g} (1)

(R.G)_{a+b}T_{c}A_{d}FₑO_{f}M_{g} (2)

(In these formulae: R represents at least one element selected from rare earth elements; M represents the elements of Groups 2 to 16, excluding the rare earth element existing within the sintered magnet before the coating of a solution containing fluorine, and also excluding C and B; and G represents at least one element selected from each of transition metal elements and rare earth elements, or at least one element selected from each of transition metal elements and alkaline earth metal elements. R and G may contain the same element. The formula (1) expresses the composition of the magnet in which R and G do not contain the same element, while the formula (2) expresses the composition of the magnet in which R and G contain the same element. T represents one or two elements selected from Fe and Co, and A represents at least one selected from B (boron) and C (carbon). Lower-case letters a to g represent atomic percents in the alloy: in the formula (1), 10≦a≦15, 0.005≦b≦2; and, in the formula (2), 10.005≦a+b≦17, 3≦d≦15, 0.01≦e≦10, 0.04≦f≦4, 0.01≦g≦11, and the rest is c.) In the rare earth permanent magnet, at least one of the constituent elements F, metalloid elements, and transition metal elements had a distribution in which the concentration averagely became higher from the center of the magnet to the surface thereof. The rare earth permanent magnet also had an averagely higher G/(R+G) concentration in the crystal grain boundary surrounding the main phase crystal grain composed of tetragonal (R, G)2T₁₄A than that in the main phase crystal grain. Moreover, the rare earth permanent magnet included an oxygen-fluoride, fluoride, or fluoride carbonate of R and G in the region of the crystal grain boundary at least 1 μm distant in depth from the magnet surface. Furthermore, the rare earth permanent magnet has a higher coercive force near the magnet surface than that in the inside thereof. As one of the characteristics, a gradient of transition metal element concentration is observed from the surface of the sintered magnet towards the center thereof. The rare earth permanent magnet can be prepared according to the following method, for example.

A treating solution for forming a rare earth fluoride or alkaline earth metal fluoride coating film added with a transition metal element was prepared according to the following steps.
(1) 4 g of salt having a high solubility to water, such as dysprosium acetate or dysprosium nitrate for Dy, was added to 100 ml of water, and dissolved completely using a shaker or an ultrasonic stirrer.
(2) HF diluted to 10% was gradually added in an equivalent amount for a chemical reaction to generate DyFₓ (x=1 to 3).
(3) The solution in which a gelled precipitation of DyFₓ (x=1 to 3) was generated was stirred for 1 hour or longer using an ultrasonic stirrer.
(4) After the solution was centrifuged at a speed ranging from 4,000 to 6,000 rpm, the supernatant was removed, and methanol was added at an amount approximately equivalent to the removed supernatant.
(5) After the methanol solution containing a gelled DyF, DyFC, or DyFO cluster was stirred thoroughly to a suspension, the suspension was stirred with an ultrasonic stirrer for one hour or longer.
(6) The steps (4) and (5) were repeated three to ten times until no anion, such as acetate ion and nitrate ion, was detected.
(7) In the case of DyF system, almost transparent DyFₓ in a sol form containing C and/or O was obtained. The methanol solution containing 1 g of DyFₓ per 5 ml of the solution was adopted as the treating solution.
(8) An organic metal compound listed in Table 2, except for carbon, was added to the solution.

It was also possible to prepare the other treating solutions used for forming a rare earth fluoride or alkaline earth metal fluoride coating film by following the almost same steps as described above. Even if being added with various elements, the fluorine-based treating solutions containing a rare earth element, such as Dy, Nd, La, and Mg, or an alkaline earth element did not exhibit a diffraction pattern corresponding with that of a fluorine compound or an oxygen-fluorine compound expressed as REₙFₘ (RE represents a rare earth element or an alkaline earth element; n and m represent positive numbers) or REₙFₘOₚCᵣ (RE represents a rare earth element or an alkaline earth element; 0, C, and F represent oxygen, carbon, and fluorine, respectively; n, m, p, and r are positive numbers), or a compound with an additive element. It was observed that the diffraction pattern of the solutions or a film formed by drying the solutions included multiple peaks as the main peaks each having a half-value width of 1° or larger. This indicated that the treating solution was different from that of the REₙFₘ in terms of an interatomic distance between the additive element and fluorine, or between the metal elements, and also in terms of crystalline structure. Since the half-value width was 1° or larger, the interatomic distance of the treating solution had a certain distribution, unlike a normal metal crystal having a constant interatomic distance. Such a distribution was caused by the presence of other atoms, mainly including hydrogen, carbon, and oxygen, located differently from those in the above-mentioned compounds, around the metal element atom or fluorine element atom. The application of an external energy, such as heat, caused these atoms, such as hydrogen, carbon, and oxygen, to easily migrate, resulting in changes in the structure and fluidity. The X-ray diffraction pattern of the sol and the gel, whose peaks had a half-value width larger than 1°, exhibited a structural change by a thermal treatment, and a part of a diffraction pattern of the REₙFₘ, REₙ(F, C, O)ₘ, or REₙ(F, O)ₘ appeared. The diffraction peak of the REₙFₘ or the like had a narrower half-value width than that of the above-described sol or gel. In order to obtain a coating film having a uniform thickness by increasing the fluidity of the solution, it was important to have at least one peak having a half-value width of 1° or larger in the diffraction pattern of the solution.
(9) A block of NdFeB sintered body (10 mm×10 mm×10 mm) or the NdFeB-based magnetic powder was immersed in the treating solution for forming a DyF-based coating film, and then the block was placed under a reduced pressure of 2 to 5 Torr for removal of the solvent methanol.
(10) The step (9) was repeated 1 to 5 times, and the block was heated at a temperature ranging from 400° C. and 1100° C. for 0.5 hours to 5 hours.
(11) A pulsed magnetic field of 30 kOe or stronger was applied to the sintered magnet or the NdFeB-based magnetic powder provided with a surface coating film in the step (10) in the anisotropy direction.

A demagnetization curve of the magnetized sample was measured by placing the sample between the magnetic poles of a DC M-H loop measurement device such that the magnetization direction of the compact agreed with the direction of the applied magnetic field, and then applying the magnetic field between the magnetic poles. The magnetic pole pieces for the application of the magnetic field to the magnetized sample were made of an FeCo alloy. The values of magnetization were corrected using a pure Ni sample and a pure Fe sample having the same shape.

As a result, the block of NdFeB sintered body having the rare earth fluoride coating film formed thereon acquired an increased coercive force. By using the treating solution added with the transition metal element, the sintered body acquired a higher coercive force or squareness of the demagnetization curve than that of a sintered magnet having no additive element. Such a further increase of the coercive force or the squareness which had been already increased by the coating of the solution with no additive element and by the subsequent thermal treatment, indicated that these additive elements contributed to the increase of coercive force. In the vicinity of the element added to the solution, a short-range structure was observed due to the removal of the solvent. Further heating caused the element to diffuse together with the constituent element of the solution along the grain boundary of the sintered magnet. The additive elements showed a tendency of segregating together with some of the constituent elements of the solution near the grain boundary. In the sintered magnet exhibiting a high coercive force, the concentration of the constituent element of the fluoride solution showed a tendency of being high in the periphery of the magnet and low at the center thereof. This is because, while the fluoride or oxygen-fluoride including the additive element and having the short-range structure grew on the outer surface of the sintered magnet block which had been coated on the outer surface with the fluoride solution including the additive element and then which had been dried, the additive element continued to diffuse along the vicinity of the grain boundary. Hence, the sintered magnet block exhibited a concentration gradient or a concentration difference, from the periphery to the inside of the block, of the fluorine and at least one of the additive elements listed in Table 2 including the transition metal elements or metalloid elements. When a transition element was added to one of a fluoride, oxide, and oxygen-fluoride including at least one rare earth element in a slurry form, the improvement in magnetic characteristics, such as high coercive force compared to the case of providing no additive element, was observed. However, more significant improvement in magnetic characteristics, such as an increased coercive force, was observed when the transition metal element or metalloid element was added to a transparent solution. Even when no rare earth element and alkaline earth element was provided, it was observed that magnetic characteristics were improved by preparing a fluoride solution including the additive element shown in Table 2, and then by coating the solution on a magnetic body. The additive elements have any of the following roles: 1) to reduce an interface energy by segregating near a grain boundary; 2) to increase the lattice matching of a grain boundary; 3) to reduce defects of a grain boundary; 4) to promote grain boundary diffusion of a rare earth element and the like; 5) to increase a magnetic anisotropic energy near a grain boundary; 6) to smooth the interface with a fluoride, an oxygen-fluoride, or a fluoride carbonate; 7) to increase anisotropy of a rare earth element; 8) to remove oxygen from the mother phase; 9) to raise a Curie temperature of the mother phase; and 10) to change an electron structure of a grain boundary by being bound to other elements segregating in the grain boundary. As a result, any of the following effects were observed: an increase of coercive force; improvement of squareness of a demagnetization curve; increase of residual magnetic flux density; improvement of energy product; raise of Curie temperature; reduction of magnetic field for magnetization; reduction in temperature dependence of coercive force and residual magnetic flux density; enhancement of corrosion resistance; increase of specific resistance; and decrease of thermal demagnetization rate. The transition metal additive elements or metalloid elements added to the solution and caused to diffuse were likely to segregate in a grain boundary phase, at the edge of the grain boundary, or in the outer edge in the grain from the grain boundary towards the interior of the grain (grain boundary side). Since these additive elements were caused to diffuse by heating after being treated with the solution, they were highly concentrated in the vicinity of the grain boundary where the fluorine or the main component of the fluoride solution segregates, unlike the composition distribution of element added to the sintered magnet in advance. The pre-added element segregated near the grain boundary where little segregation of fluorine occurred. Thus, an averaged concentration gradient was observed from the outermost surface of the magnet block to the inside thereof. However, it was also possible to improve magnetic characteristics even if the additive element segregated independently from the site of fluorine segregation. When the concentration of the additive element was low in the solution, the concentration gradient or concentration difference were observed in the comparative analysis of a sample prepared by cutting the magnetic block. As described above, when a magnet block was coated with a solution including an additive element, and then heated for improvement of the characteristics of a sintered magnet, the sintered magnet thus obtained exhibited the following characteristics: 1) a concentration gradient or an averaged concentration difference of at least one element of the atomic numbers from 18 to 86, such as transition metal elements and metalloid elements, added to a solution having a fluoride as the main component, was observed from the outermost surface of the sintered magnet to the inside thereof, and the concentration tended to decrease from the surface of the magnet to the inside thereof; 2) the segregation of the transition metal element or metalloid element added to the solution near the grain boundary of the magnet was observed upon involving fluorine, the concentration distribution of fluorine and the concentration profile of the additive element were similar in some cases, while other cases showed the segregation of additive element without fluorine involved, and some of the additive elements were incorporated into the mother phase without segregating; 3) the concentration of fluorine was high in the grain boundary phase, and low on the outside of the grain boundary phase, the segregation of additive elements, such as transition metal element, may be observed near the region where the fluorine concentration difference was observed, and an averaged concentration gradient and/or concentration difference was observed from the surface of the magnet block toward the inside thereof; 4) a layer containing the transition metal element, fluorine, and carbon, or an oxygen-fluorine compound or fluoride including any of elements of the atomic numbers from 18 to 86 grew with a thickness ranging from 1 nm to 10,000 nm on the outermost surface of the sintered magnet. This layer containing the fluorine partly included the constituent element of the sintered magnet; thus, it was possible to remove such a surface layer by applying a treatment, such as polishing, on a final product; and 5) the concentration gradient of the additive element added before the solution treatment was different from that of the element added during the solution treatment: the former was independent from an averaged concentration gradient of the main component of the fluoride solution, such as fluorine, and the latter exhibited the dependency on at least one constituent element of the fluoride solution in the concentration profile.

### EXAMPLE 31

A rapidly-cooled powder mainly composed of Nd₂Fe₁₄B as the NdFeB-based powder was prepared, and a fluorine compound was formed on the surface of the powder. When DyF₃ was formed on the surface of the rapidly-cooled powder, Dy(CH₃COO)₃ as the raw material was dissolved in H₂O, and HF was added thereto. The addition of HF caused formation of gelatin-like DyF₃.XH₂O. This solution was centrifuged to have the solvent removed. Having a concentration of rare earth fluoride in a sol form of 10 g/dm³ or above, the treating solution exhibited a transmittance of 5% or above measured at a light path length of 1 cm at a wavelength of 700 nm. Such an optically transparent solution was added with a compound or solution including at least one of transition metal elements and metalloid elements. The solution after the addition exhibited a broad X-ray diffraction peak having a half-value width ranging from 1° to 10°, and therefore had fluidity. This solution and the NdFeB powder were mixed. After the solvent of the mixture was evaporated, the hydration water was evaporated by heat. It was found that the crystalline structure of the fluorine compound film included a NdF₃ structure, NdF₂ structure, which contained the additive element, or an oxygen-fluoride and the like by the thermal treatment at a temperature ranging from 500° C. to 800° C. In addition to the segregation of Dy and Nd and the segregation of Nd, Dy and fluorine in plate-like bodies, in the diffusion path in the magnetic particle, the segregation of the additive element was observed. Thus, magnetic characteristics were improved by increased anisotropic energy, improved lattice matching in the grain boundary, reduction reaction of the mother phase by fluorine, and the like. In order to reduce the use of heavy rare earth element, at least one of metalloid elements and transition metal elements was caused to segregate in the vicinity of the grain boundary by the surface treatment using a fluoride solution added with a metalloid and/or transition metal element and by the subsequent diffusion. As a result, the NdFeB-based magnetic powder exhibited any of the following effects: an increase of coercive force; improvement of squareness of a demagnetization curve; increase of residual magnetic flux density; improvement of energy product; raise of Curie temperature; reduction of magnetic field for magnetization; reduction in temperature dependence of coercive force and residual magnetic flux density; enhancement of corrosion resistance; increase of specific resistance; and decrease of thermal demagnetization rate. Hence, the above-described improvement in magnetic characteristics was achieved in a magnetic powder for bonded magnet, hot molded anisotropic magnetic powder, and hot molded anisotropic sintered magnet.

### EXAMPLE 32

A rare earth permanent magnet, which was a sintered magnet, was obtained by causing a fluorine atom and a G component (G represents at least one element selected from rare earth elements, and at least one element selected from metal elements of Groups 3 to 11, except for rare earth elements, or from elements of Groups 2 and 12 to 16, except for C and B) to diffuse into an R—Fe—B-based sintered magnet (R represents a rare earth element) from the surface thereof. The composition of the rare earth permanent magnet is expressed by one of the following composition formulae (1) and (2):

RₐG_{b}T_{c}A_{d}FₑO_{f}M_{g} (1)

(R.G)_{a+b}T_{c}A_{d}FₑO_{f}M_{g} (2)

(In these formulae: R represents at least one element selected from rare earth elements; M represents the elements of Groups 2 to 16, excluding the rare earth element existing within the sintered magnet before the coating of a solution containing fluorine, and also excluding C and B; and G represents at least one element selected from each of rare earth elements and metal elements which include metal elements of Groups 3 to 11 except for rare earth elements or elements of Groups 2 and 12 to 16, except for C and B, or at least one element selected from each of alkaline earth metal elements and metal elements which include metal elements of Groups 3 to 11 except for rare earth elements or elements of Groups 2 and 12 to 16, except for C and B. R and G may contain the same element. The formula (1) expresses the composition of the magnet in which R and G do not contain the same element, while the formula (2) expresses the composition of the magnet in which R and G contain the same element. T represents one or two elements selected from Fe and Co, and A represents at least one selected from B (boron) and C (carbon). Lower-case letters a to g represent atomic percents in the alloy: in the formula (1), 10≦a≦15, 0.005≦b≦2; and, in the formula (2), 10.005≦a+b≦17, 3≦d≦15, 0.01≦e≦10, 0.04≦f≦4, 0.01≦g≦11, and the rest is c.) In the rare earth permanent magnet, at least one of the constituent elements F and metal elements, which were the elements of Groups 2 to 16 except for rare earth elements, C, and B, had a distribution in which the concentration averagely became higher from the center of the magnet to the surface thereof. The rare earth permanent magnet also had an averagely higher G/(R+G) concentration in the crystal grain boundary surrounding the main phase crystal grain composed of tetragonal (R, G)₂T₁₄A than that in the main phase crystal grain. Moreover, the rare earth permanent magnet includes an oxygen-fluoride, fluoride, or fluoride carbonate of R and G in the region of the crystal grain boundary at least 1 μm distant in depth from the magnet surface. Furthermore, the rare earth permanent magnet has a higher coercive force near the magnet surface than that in the inside thereof. As one of the characteristics, a concentration gradient or concentration difference of the metal elements (elements of Groups 2 to 16 except for rare earth elements, C, and B) is observed from the surface of the sintered magnet towards the center thereof. The rare earth permanent magnet can be prepared according to the following method, for example.

A treating solution for forming a rare earth fluoride or alkaline earth metal fluoride coating film added with a metal element (which is any of metal elements of Groups 3 to 11 except for rare earth elements, and elements of Groups 2 and 12 to 16 except for C and B) was prepared according to the following steps.
(1) 1 to 10 g of salt having a high solubility to water, such as dysprosium acetate or dysprosium nitrate for Dy, were added to 100 ml of water, and dissolved completely using a shaker or an ultrasonic stirrer.
(2) HF diluted to 10% was gradually added in an equivalent amount for a chemical reaction to generate DyFₓ (x=1 to 3).
(3) The solution in which a gelled precipitation of DyFₓ (x=1 to 3) was generated was stirred for 1 hour or longer using an ultrasonic stirrer.
(4) After the solution was centrifuged at a speed ranging from 4,000 to 10,000 rpm, the supernatant was removed, and methanol was added at an amount approximately equivalent to the removed supernatant.
(5) After the methanol solution containing a gelled DyF, DyFC, or DyFO cluster was stirred thoroughly to a suspension, the suspension was stirred with an ultrasonic stirrer for one hour or longer.
(6) The steps (4) and (5) were repeated three to ten times until no anion, such as acetate ion and nitrate ion, was detected.
(7) In the case of DyF system, almost transparent DyFₓ in a sol form containing C and/or O was obtained. The methanol solution containing 1 g of DyFₓ per 5 ml of the solution was adopted as the treating solution.
(8) An organic metal compound including at least one of the metal elements (which are metal elements of Groups 3 to 11 except for rare earth elements, or elements of Groups 2 and 12 to 16 except for C and B) was added to the solution.

It was also possible to prepare the other treating solutions used for forming a rare earth fluoride, alkaline earth metal fluoride, or Group 2 metal fluoride coating film by following the almost same steps as described above. Even if being added with various elements, the fluorine-based treating solutions containing a rare earth element, such as Dy, Nd, La, and Mg, an alkaline earth element, or a metal element of Group 2 did not exhibit a diffraction pattern corresponding with that of a fluorine compound or an oxygen-fluorine compound expressed as REₙFₘ (RE represents a rare earth element, a metal element of Group 2 or an alkaline earth element; n and m represent positive numbers) or REₙFₘOₚCᵣ (RE represents a rare earth element, a metal element of Group 2 or an alkaline earth element; O, C, and F represent oxygen, carbon, and fluorine, respectively; n, m, p, and r are positive numbers), respectively, or a compound with an additive element. It was observed that the X-ray diffraction pattern of the solution or a film formed by drying the solution included peak having a half-value width of 1° or larger as the main peak. This indicated that the treating solution was different from that of REₙFₘ in terms of an interatomic distance between the additive element and fluorine, or between the metal elements, and also in terms of crystalline structure. Since the half-value width was 1° or larger, the interatomic distance of the treating solution had a certain distribution, unlike a normal metal crystal having a constant interatomic distance. Such a distribution was caused by the presence of other atoms, mainly including hydrogen, carbon, and oxygen, located differently from those in the above-mentioned compounds around the metal element atom or fluorine element atom. The application of an external energy, such as heat, caused these atoms, such as hydrogen, carbon, and oxygen, to easily migrate, and thereby changed the structure and fluidity. The X-ray diffraction pattern of the sol and the gel, whose peak had a half-value width larger than 1°, exhibited a structural change by a thermal treatment, and a part of a diffraction pattern of the REₙFₘ, REₙ(F, C, O)ₘ, or REₙ (F, O)ₘ appeared. The diffraction peak of the REₙFₘ or the like had a narrower half-value width than that of the diffraction peak of the sol or gel. In order to obtain a coating film having a uniform thickness by increasing the fluidity of the solution, it was important to have at least one peak having a half-value width of 0.5° or larger in the diffraction pattern of the solution.
(9) A block of NdFeB sintered body (100 mm×100 mm×100 mm) or a NdFeB-based magnetic powder was immersed in the treating solution for forming a DyF-based coating film, and then the block was placed under a reduced pressure of 2 to 5 Torr for removal of the solvent methanol.
(10) The step (9) was repeated 1 to 5 times, and the block was heated at a temperature ranging from 400° C. and 1100° C. for 0.5 hours to 5 hours.
(11) A pulsed magnetic field of 30 kOe or stronger was applied to the sintered magnet or the NdFeB-based magnetic powder provided with a surface coating film in the step (10) in the anisotropy direction.

A demagnetization curve of the magnetized sample was measured by placing the sample between the magnetic poles of a DC M-H loop measurement device such that the magnetization direction of the compact agreed with the direction of the applied magnetic field, and then applying the magnetic field between the magnetic poles. The magnetic pole pieces for the application of the magnetic field to the magnetized sample were made of an FeCo alloy. The values of magnetization were corrected using a pure Ni sample and a pure Fe sample having the same shape.

As a result, the block of NdFeB sintered body having the rare earth fluoride coating film formed thereon acquired an increased coercive force. By using the treating solution added with the metal element (metal elements of Groups 3 to 11 except for rare earth elements, or elements of Groups 2 and 12 to 16 except for C and B), the sintered body acquired higher coercive force or squareness of an demagnetization curve than that of a sintered magnet which was coated with a heavy rare earth fluoride treating solution only, with no coating of a solution containing an additive element, and then which was caused to diffuse. Such a further increase of the coercive force or squareness which had already been increased by the coating of the solution with no additive element and by the subsequent thermal treatment, indicated that these additive elements contributed to the increase of coercive force. In the vicinity of the element added to the solution, a short-range structure was partly observed due to the removal of the solvent. Further heating caused the element to diffuse together with the constituent element of the solution along the grain boundary of the sintered magnet. Some of the metal elements (metal elements of Groups 3 to 11 except for rare earth elements, or elements of Groups 2 and 12 to 16 except for C and B) showed a tendency of segregating together with some of the constituent elements of the solution near the grain boundary. In the sintered magnet exhibiting a high coercive force, the concentration of the constituent element of the fluoride solution showed a tendency of being high in the periphery of the magnet and low at the center thereof. This is because, while the fluoride or oxygen-fluoride including the additive element and having the short-range structure grew on the outer surface of the sintered magnet block which had been coated on the outer surface with the fluoride solution including the additive element and then which had been dried, the additive element continued to diffuse along the vicinity of the grain boundary. Hence, the sintered magnet block exhibited a concentration gradient or a concentration difference, from the periphery to the inside of the block, of the fluorine and at least one of the metal elements (metal elements of Groups 3 to 11 except for rare earth elements, or elements of Groups 2 and 12 to 16 except for C and B). When a transition metal element was added to one of a fluoride, oxide, and oxygen-fluoride including at least one rare earth element in a slurry form composed of a ground fluoride powder, the improvement in magnetic characteristics, such as high coercive force compared to the case of providing no additive element, was observed. However, more significant improvement in magnetic characteristics, such as an increased coercive force, was observed when a transition metal element or metalloid element was added to a transparent solution. This is because the transition metal element or metalloid element was dispersing uniformly in the fluoride solution at the atomic level, the transition metal element or metalloid element in the fluoride film was uniformly dispersing having a short-range structure, and these elements dispersed at a low temperature along the grain boundary as the constituent elements of the solution, such as fluorine, disperse. The metal elements (elements of Groups 2 to 16 except for rare earth elements, C, and B) as the additive elements have any of the following roles: 1) to reduce an interface energy by segregating near a grain boundary; 2) to increase the lattice matching of a grain boundary; 3) to reduce defects of a grain boundary; 4) to promote grain boundary diffusion of a rare earth element and the like; 5) to increase a magnetic anisotropic energy near a grain boundary; 6) to smooth the interface with a fluoride, an oxygen-fluoride, or a fluoride carbonate; 7) to increase anisotropy of a rare earth element; 8) to remove oxygen from the mother phase; 9) to raise a Curie temperature of the mother phase; and 10) to reduce the use of rare earth element, in other words, when the additive elements was used, it was possible to reduce the use of heavy rare earth element by 1% to 50% compared to a magnet having the same coercive force; 11) to contribute to improving erosion resistance and enhancing resistivity by forming an oxide-fluoride or fluoride containing the additive element and having a thickness ranging from 1 nm to 10,000 nm on the surface of the sintered magnet block; 12) to promote segregation of the element added to the sintered magnet in advance; 13) to demonstrate reduction action by causing oxygen in the mother phase to diffuse into the grain boundary or to reduce the mother phase by being bound to oxygen; 14) to promote the ordering of the grain boundary phase, while some additive elements stay in the grain boundary phase; 15) to inhibit growth of the phase containing fluorine at the grain boundary triple point; 16) to accelerate concentration distribution of the heavy rare earth element or fluorine atom at the grain boundary and the mother phase interface; 17) to lower the temperature for liquid phase formation near the grain boundary by diffusing together with fluorine, carbon, or oxygen; and 18) to increase the magnetic moment of the mother phase by segregating with fluorine in the grain boundary. As a result, any of the following effects were observed: an increase of coercive force; improvement of squareness of a demagnetization curve; increase of residual magnetic flux density; improvement of energy product; raise of Curie temperature; reduction of magnetic field for magnetization; reduction in temperature dependence of coercive force and residual magnetic flux density; enhancement of corrosion resistance; increase of specific resistance; and decrease of thermal demagnetization rate; and improvement of erosion resistance. The metal elements (elements of Groups 2 to 16 except for rare earth elements, C, and B) added to the solution and caused to disperse were likely to segregate in a grain boundary phase, at the edge of the grain boundary, in the outer edge in the grain from the grain boundary towards the interior of the grain (grain boundary side), or in the vicinity of the interface between the magnet surface and the fluoride. Since these additive elements were caused to diffuse by heating after being treated with the solution, they were highly concentrated in the vicinity of the grain boundary where the fluorine or the main component of the fluoride solution segregated, unlike the composition distribution of element added to the sintered magnet in advance. The pre-added element segregated in the grain boundary where little segregation of fluorine occurred. Thus, an averaged concentration gradient or concentration difference was observed from the outermost surface of the magnet block to the inside thereof. As described above, when a magnet block was coated with a solution including an additive element, and then heated for improvement of the characteristics of a sintered magnet, the sintered magnet with the diffused additive element exhibited the following characteristics: 1) a concentration gradient or an averaged concentration difference of the metal elements (elements of Groups 2 to 16 except for rare earth elements, C, and B) was observed from the outermost surface of the sintered magnet to the inside thereof, and the concentration tended to decrease from the surface of the magnet to the inside thereof; 2) the segregation of the metal elements (elements of Groups 2 to 16 except for rare earth elements, C, and B) added to the solution near the grain boundary of the magnet was observed upon involving fluorine, and a relation or correlativity was observed between the concentration distributions of fluorine and additive element; 3) the concentration of fluorine was high in the grain boundary phase, and low outside of the grain boundary phase. The segregation of metal elements (elements of Groups 2 to 16 except for rare earth elements, C, and B) was observed near the region where the fluorine concentration difference was observed. An averaged concentration gradient and/or concentration difference was observed from the surface of the magnet block toward the inside thereof; 4) a layer containing the metal elements (elements of Groups 2 to 16 except for rare earth elements, C, and B), fluorine, and carbon grew on the outermost surface of the sintered magnet; and 5) the concentration gradient of the additive element added before the solution treatment was different from that of the element added during the solution treatment: the former was independent from an averaged concentration gradient of the main component of the fluoride solution, such as fluorine, and the latter exhibited a strong correlation or correlativity with at least one constituent element of the fluoride solution in terms of the concentration profile.

### EXAMPLE 33

A treating solution for forming a rare earth fluoride or alkaline earth metal fluoride coating film was prepared according to the following steps.
(1) 4 g of salt having a high solubility to water, such as neodymium acetate or neodymium nitrate for Nd, was added to 100 ml of water, and dissolved completely using a shaker or an ultrasonic stirrer.
(2) HF diluted to 10% was gradually added in an equivalent amount for a chemical reaction to generate NdFₓC_{y} (x and y are positive numbers).
(3) The solution in which a gelled precipitation of NdFₓC_{y} (x and y are positive numbers) was generated was stirred for 1 hour or longer using an ultrasonic stirrer.
(4) After the solution was centrifuged at a speed ranging from 4,000 to 6,000 rpm, the supernatant was removed, and methanol was added at an amount approximately equivalent to the removed supernatant.
(5) After the methanol solution containing a gelled NdFC cluster was stirred thoroughly to a suspension, the suspension was stirred with an ultrasonic stirrer for one hour or longer.
(6) The steps (4) and (5) were repeated three to ten times until no anion, such as acetate ion and nitrate ion, was detected.
(7) In the case of NdFC system, almost transparent NdFₓC_{y} (x and y are positive numbers) in a sol form was obtained. The methanol solution containing 1 g of NdFₓC_{y} (x and y are positive numbers) per 5 ml of the solution was adopted as the treating solution.
(8) An organic metal compound listed in Table 2, except for carbon, was added to the solution.

It was possible to prepare the other treating solutions used for forming a coating film mainly containing a rare earth fluoride or alkaline earth metal fluoride by following the almost same steps as described above. Even if being added with various elements, the fluorine-based treating solutions containing Dy, Nd, La, Mg as shown in Table 2, alkaline earth element, and Group 2 element did not exhibit a diffraction pattern corresponding with that of a fluorine compound expressed as REₙFₘCₚ (RE represents a rare earth element or an alkaline earth element; n, m, and p represent positive numbers), an oxygen-fluorine compound or a compound with an additive element. The solution structure was not largely changed by the additive element in the content range shown in Table 2. It was observed that the diffraction pattern of the solution or a film formed by drying the solution included multiple peaks each having a half-value width of 1° or larger. This indicated that the treating solution was different from that of REₙFₘCₚ in terms of an interatomic distance between the additive element and fluorine, or between the metal elements, and also in terms of crystalline structure. Since the half-value width was 1° or larger, the interatomic distance of the treating solution had a certain distribution, unlike a normal metal crystal having a constant interatomic distance. Such a distribution was caused by the presence of other atoms, mainly including hydrogen, carbon, and oxygen, located differently from those in the above-mentioned compounds around the metal element or fluorine element atom. The application of an external energy, such as heat, caused these atoms, such as hydrogen, carbon, and oxygen, to easily migrate, and thereby changed the structure and fluidity. The X-ray diffraction pattern of the sol and the gel, whose peak had a half-value width of 1° or larger, exhibited a structural change by a thermal treatment, and a part of a diffraction pattern of the REₙFₘCₚ or REₙ(F, O, C)ₘ appeared. It was also assumed that a majority of the additive elements listed in Table 2 had no long-period structure in the solutions. The diffraction peak of the REₙFₘCₚ had a narrower half-value width than that of the diffraction peak of the sol or gel. In order to obtain a coating film having a uniform thickness by increasing the fluidity of the solution, it was important to have at least one peak having a half-value width of 1° or larger in the diffraction pattern of the solution. Such a peak having a half-value width of 1° or larger, and the diffraction pattern of REₙFₘCₚ or a peak of an oxygen-fluorine compound may be included in the diffraction pattern of the solution. In the case where only the diffraction pattern of the REₙFₘCₚ or the oxygen-fluorine compound, or where a diffraction pattern having 1° or smaller was observed, mainly in the diffraction pattern of the solution, it was difficult to provide a uniform coating due to poor fluidity caused by the presence of solid phase, not in a sol or gel form, in the solution.
(9) A block of NdFeB sintered body (10 mm×10 mm×10 mm) was immersed in the treating solution for forming a NdF-based coating film, and then the block was placed under a reduced pressure of 2 to 5 Torr for removal of the solvent methanol.
(10) The step (9) was repeated 1 to 5 times, and the block was heated at a temperature ranging from 400° C. and 1,100° C. for 0.5 hours to 5 hours.
(11) A pulsed magnetic field of 30 kOe or stronger was applied to the anisotropic magnet provided with a surface coating film in the step (10) in the anisotropy direction.

A demagnetization curve of the magnetized compact was measured by placing the compact between the magnetic poles of a DC M-H loop measurement device such that the magnetization direction of the compact agreed with the direction of the applied magnetic field, and then applying the magnetic field between the magnetic poles. The magnetic pole pieces for the application of the magnetic field to the magnetized compact were made of an FeCo alloy. The values of magnetization were corrected using a pure Ni sample and a pure Fe sample having the same shape.

As a result, the block of NdFeB sintered body having the rare earth fluoride coating film formed thereon and sequentially heated acquired an increased coercive force. With no additive element, the coercive forces of sintered magnets having carbon-fluoride or carbon-fluorine oxide compound containing Dy, Nd, La, and Mg segregated therein were increased by 40%, 30%, 25%, and 20%, respectively. In order to further increase the coercive force which had already been increased by coating with the solution having no additive element and then by heating, the additive elements listed in Table 2 were added to the fluorine solutions using an organic metal compound. Compared to the coercive force in the case of the solution having no additive element as a reference, the coercive force of the sintered magnet was further increased; thus, it was revealed that these additive elements contributed to the increase of a coercive force. In the vicinity of the element added to the solution, a short-range structure was observed due to the removal of the solvent. Further heating caused the element to diffuse together with the constituent element of the solution along the grain boundary or various defects of the sintered magnet. The additive elements showed a tendency of segregating together with some of the constituent elements of the solution near the grain boundary. The additive elements listed in Table 2 diffused together with at least one of fluorine, oxygen, and carbon into the sintered magnet, and some of the elements stayed near the grain boundary. In the sintered magnet exhibiting a high coercive force, the concentration of the constituent element of the carbon-fluoride solution showed a tendency of being high in the periphery of the magnet and low at the center thereof. This is because, while the fluoride, fluoride carbonate, a carbon-fluoride, or an oxygen-fluoride including the additive element and having the short-range structure grew on the outer surface of the sintered magnet block which had been coated with the fluoride solution including the additive element, and then which had been dried, the additive element continued to diffuse along the grain boundary, cracks, or an area around the defects. Hence, the sintered magnet block exhibited a concentration gradient or concentration difference, from the periphery to the inside of the block, of the fluorine and at least one of the metal elements of Groups 3 to 11 including the additive elements listed in Table 2 or the elements of Groups 2 and 12 to 16. The content of these elements was approximately consistent with the range in which the solutions retained the optical transparencies. It was also possible to prepare a solution containing higher concentration of additive elements, and thus to further increase the coercive force. When an element from the metal elements of Groups 3 to 11 or the elements of Groups 2 and 12 to 16 except for B was added to any one of a fluoride, oxide, carbon-fluoride, fluoride carbonate, and oxygen-fluoride including at least one rare earth element in a slurry form, the improvement in magnetic characteristics, such as high coercive force compared to the case of providing no additive element, was also observed. When the additive element having a concentration more than 1,000 times higher than that shown in Table 2 was added, the structure of the fluoride composing the solution was changed, resulting in a nonuniform distribution of the additive element in the solution which tended to inhibit diffusion of other elements. Thus, it became difficult to cause the additive element to segregate along the grain boundary to reach the inside of the magnet block; however, an increase of a coercive force was locally observed. The metal elements of Groups 3 to 11 and the additive elements of Groups 2 and 12 to 16, except for B, have any of the following roles: 1) to reduce the interface energy by segregating near a grain boundary; 2) to increase the lattice matching of a grain boundary; 3) to reduce defects of a grain boundary; 4) to promote grain boundary diffusion of a rare earth element and the like; 5) to increase a magnetic anisotropic energy near a grain boundary; and 6) to smooth the interface with a fluoride or an oxygen-fluoride. As a result, the process of coating a solution with the additive elements followed by the diffusion and heating processes provided any of the following effects: an increase of coercive force; improvement of squareness of a demagnetization curve; increase of residual magnetic flux density; improvement of energy product; raise of Curie temperature; reduction of magnetic field for magnetization; reduction in temperature dependence of coercive force and residual magnetic flux density; enhancement of corrosion resistance; increase of specific resistance; and decrease of thermal demagnetization rate. The concentration distribution of the metal elements of Groups 3 to 11 and the additive elements of Groups 2 and 12 to 16, except for B, showed that the concentration tended to go down averagely from the peripheral to the inside of the sintered magnet, and to be high in a grain boundary region or the outer surface. The widths of an area near a grain boundary triple point and of an area distant from the grain boundary triple point tended to be different, and the width of the area near the grain boundary triple point tended to be wider. The average grain boundary width ranged from 0.1 nm to 20 nm. A part of the additive elements segregated in the area stretching from the grain boundary and having a width ranging 1 fold to 1,000-folds of the grain boundary width. The concentration of the segregated additive elements tended to averagely decrease from the surface of the magnet to the inside thereof. Some fluorine existed a part of the grain boundary phase. The additive elements were likely to segregate in a grain boundary phase, at the edge of the grain boundary, or in the outer edge in the grain from the grain boundary towards the interior of the grain (grain boundary side). The improvement in magnetic characteristics of the magnet was observed with the following additive elements in the solution: Mg, Al, Si, Ca, Ti, V, Cr, Mn, Fe, Co, Ni, Cu, Zn, Ga, Ge, Sr, Zr, Nb, Mo, Pd, Ag, In, Sn, Hf, Ta, W, Ir, Pt, Au, Pb, and Bi, which are listed in Table 2; and elements selected from the elements of the atomic numbers from 18 to 86 which include all the transition metal elements. The sintered magnet exhibited an averaged concentration gradient of the fluorine and at least one of the above-listed elements from the periphery of the magnet to the inside thereof, and from the grain boundary to the grain interior. The concentration gradient or concentration difference of the metal elements of Groups 3 to 11 or the additive elements of Groups 2 and 12 to 16 except for B near the grain boundary and in the grain interior averagely changed across from the periphery of the magnet to the center thereof, and tended to be smaller as coming closer to the center of the magnet. If these additive elements diffused sufficiently, a concentration difference thereof and segregation thereof in the vicinity of the grain boundary including fluorine were observed. Since these additive elements were caused to diffuse by heating after being treated with the solution, they were highly concentrated in the vicinity of the grain boundary where the fluorine segregated, unlike the composition distribution of element added to the sintered magnet in advance. The pre-added element segregated near the grain boundary where little segregation of fluorine occurred. Thus, an averaged concentration gradient was observed from the outermost surface of the magnet block to the inside thereof. Even when the concentration of additive element was low in the solution, the concentration difference was observed between the outermost surface of the magnet and the center thereof, and therefore the concentration gradient or the concentration difference between the grain boundary and grain interior were observed. As described above, when a magnet block was coated with a solution including an additive element, and then heated for improvement of the characteristics of a sintered magnet, the sintered magnet thus obtained exhibited the following characteristics: 1) a concentration gradient or an averaged concentration difference of the elements listed in Table 2 or the elements of the atomic numbers from 18 to 86 including the transition metal elements was observed from the outermost surface of the sintered magnet to the inside thereof, the outermost surface included a reaction layer to a layer including fluorine; 2) the segregation of the elements listed in Table 2 or the elements of the atomic numbers from 18 to 86 including the transition metal elements near the grain boundary was observed upon involving fluorine, carbon, and oxygen in many cases; 3) the concentration of fluorine was high in the grain boundary phase, and low on the outside of the grain boundary phase (periphery of the crystal grain). The segregation of the elements listed in Table 2 or the element of the atomic numbers from 18 to 86 was observed in the region, where fluorine concentration difference was observed, stretching from the grain boundary and having a width 1,000-folds of the grain boundary width. An averaged concentration gradient and/or concentration difference was observed from the surface of the magnet block toward the inside thereof; 4) the highest concentration of the fluorine and additive element was observed in the outermost surface of the sintered magnet block, the magnet powder, or the ferromagnetic powder, which was coated with the solution, and a concentration gradient or a concentration difference of the additive element was observed from the edge of the magnetic body part to the inside thereof; 5) at least one constituent element of the solution including the additive elements listed in Table 2 or the elements of the atomic numbers from 18 to 86 had a concentration gradient from the surface to the inside, the highest fluorine concentration was observed near the interface between the magnet grown out of the solution and the film containing fluorine or outside of the interface viewed from the magnet side, and the fluoride near the interface included oxygen or carbon, contributing to any of high corrosion resistance, high electric resistance, or high magnetic characteristics. In the film containing fluorine, at least one of the additive elements listed in Table 2 and the elements of the atomic numbers from 18 to 86 was detected. A large amount of these additive elements was contained near the diffusion path of fluorine inside of the magnet. Therefore, any of the following effects were observed: an increase of coercive force; improvement of squareness of a demagnetization curve; increase of residual magnetic flux density; improvement of energy product; raise of Curie temperature; reduction of magnetic field for magnetization; reduction in temperature dependence of coercive force and residual magnetic flux density; enhancement of corrosion resistance; increase of specific resistance; decrease of thermal demagnetization rate; decrease of diffusion temperature; inhibition of growth of grain boundary width; and inhibition of growth of nonmagnetic layer in a grain boundary. Concentration difference of the additive elements can be examined on the basis of an EDX profile obtained by transmission electron microscopy or by analyzing a sintered block cut from the surface towards the inside using an analytical method, such as EPMA and ICP analysis. Segregation of the elements of the atomic numbers from 18 to 86 added to the solution in the vicinity of a fluorine atom (a region within 5,000 nm, preferably 1,000 nm, from the site of fluorine atom segregation) can be analyzed on the basis of an EDX profile obtained by transmission electron microscopy or using EELS. The ratio, at an inside position at least 100 μm distant from the magnet surface, between the additive element segregated in the vicinity of fluorine atom and the additive element located in a part at least 2,000 nm distant from the site of segregation of fluorine atom ranges from 1.01 to 1,000, preferably 2 or higher. On the surface of the magnet, the ratio was 2 or higher. The additive elements, which segregated either continuously or discontinuously along the grain boundary and did not necessarily segregate throughout the grain boundary, were likely to segregate discontinuously in the center side of the magnet. Some of the additive elements were averagely incorporated into the mother phase without segregating. The ratio of the additive elements of the atomic numbers from 18 to 86 diffusing in the mother phase or the concentration of the elements segregating in the vicinity of the fluorine segregation site tended to be lower from the surface of the sintered magnet to the inside thereof. Due to such a concentration distribution, the coercive force tended to be higher near the surface than that in the inside of the magnet. The improvement in magnetic characteristics such as hard magnetic characteristics and increase of electric resistance of magnetic powder, that described above was obtained not only for the sintered magnetic block, but also for an N-Fe—B-based magnetic powder, a SmCo-based magnetic powder, or a Fe-based magnetic powder provided with a film containing fluorine and any of the additive elements using any of the solution listed in Table 2 to the surface of the magnetic powders and then heated for diffusion. Furthermore, it was possible to prepare a sintered magnet by impregnating a preliminary compact formed after preliminary molding a NdFeB powder formed in a magnetic field into any of a solution containing the metal elements of Groups 3 to 11 or the elements of Groups 2 and 12 to 16 except for C and B to provide a film containing an additive element and fluorine formed in a part of the surface of the magnetic powder, and then sintering the preliminary compact, or by sintering, together with a preliminary compact in a magnetic field, a mixture of a NdFeB-based powder having the surface treated with a solution containing the metal element of Groups 3 to 11 or the elements of Groups 2 and 12 to 16 except for C and B and an untreated NdFeB-based powder. Although having averagely uniform distributions of concentrations of the solution constituent elements, such as fluorine and additive elements included in the solution, such a sintered magnet had improved magnetic characteristics due to the averagely high concentration of the metal elements of Groups 3 to 11 or the elements of Groups 2 and 12 to 16 except for C and B in the vicinity of the diffusion path of fluorine atom. A grain boundary phase containing fluorine formed from a solution containing the metal elements of Groups 3 to 11 or the elements of Groups 2 and 12 to 16 except for C and B had an average concentration of fluorine from 0.1 to 60 atomic percent, preferably 1 to 20 atomic percent, in the segregating region. The grain boundary phase can be nonmagnetic, ferromagnetic, or antiferromagnetic, depending on concentration of additive element. Hence, it is possible to control magnetic characteristics by strengthen and weaken a magnetic bond between the ferromagnetic grain and the grain.

All references, including any publications, patents, or patent applications cited in this specification are hereby incorporated by reference in their entirely.

What is claimed is:

1. A treating composition comprising:
an alcohol based liquid; and
a rare earth fluoride dispersed in the liquid; and
a metal element including at least one selected from the group consisting of Co, Cu, Ga, Ge, Zr, Nb, Pd, Ag, In, Sn, Pt, Au, and Bi.

2. The treating composition according to claim 1, wherein the rare earth is Dy.

3. The treating composition according to claim 2, wherein the metal element includes at least one selected from the group consisting of Cu and Pt.

4. The treating composition according to claim 1, wherein the metal element includes at least one selected from the group consisting of Cu and Pt.

5. The treating composition according to claim 1, wherein the ratio of the metal element to the rare earth in the liquid ranges from 0.0001 to 1.0.

6. The treating composition according to claim 1, wherein the rare earth fluoride is dispersed in the liquid in a sol form or a gel form.

7. The treating composition according to claim 1, wherein the concentration of the rare earth fluoride in the liquid 0.1 g/dm³ to 100 g/dm³ inclusive.

8. The treating composition according to claim 1, wherein the alcohol comprises at least one selected from the group consisting of methyl alcohol, ethyl alcohol, n-propyl alcohol, and isopropyl alcohol.

9. The treating composition according to claim 1, wherein the alcohol based liquid composition comprises at least one selected from the group consisting of methyl alcohol, ethyl alcohol, n-propyl alcohol, and isopropyl alcohol in a concentration range from 50 wt % to less than 100 wt %, and at least one selected from the group consisting of acetone, methyl ethyl ketone, and methyl isobutyl ketone in a concentration range from above 0 wt % to 50 wt %.
